(19) United States
(12) Patent Application Publication
(10) Pub. No.: US 2023/0376042 A1
(43) Pub. Date: Nov. 23, 2023

(54) INTELLIGENT ELECTRIC VEHICLE WITH RECONFIGURABLE PAYLOAD SYSTEM

(71) Applicant: AYRO, Inc., Round Rock, TX (US)

(72) Inventor: Thomas M. Wittenschlaeger, Sarasota, FL (US)

(21) Appl. No.: 17/933,926

(22) Filed: Sep. 21, 2022

Related U.S. Application Data
(60) Provisional application No. 63/365,084, filed on May 20, 2022.

(51) Int. Cl. G05D 1/02; G05D 1/00

(52) U.S. Cl. CPC G05D 1/0223; G05D 1/0094; G05D 2201/0204

(57) ABSTRACT

Embodiments for an intelligent electric low speed vehicle (LSV) with a reconfigurable payload structure are described. A plurality of operational profiles respectively associated with a plurality of payload configurations are stored. A first payload configuration from the plurality of payload configurations is determined based on a first payload capability requirement for the LSV. The LSV configured with the first payload configuration is controlled with a first operational profile of the plurality of operational profiles to traverse a first area with a minimal environmental impact. The first operational profile is associated with the first payload configuration.

### RELATED APPLICATIONS

This patent application claims priority to and benefit of U.S. Provisional Patent Application 63/365,084, filed May 20, 2022, which is hereby incorporated by reference herein in its entirety. This application is also related to U.S. Patent Application______, filed Sep. 21, 2022, titled “Systems and Methods For Providing A Reconfigurable Payload System (Atty docket 58929.24US01), which is hereby incorporated by reference herein in its entirety.

### FIELD OF THE INVENTION

The field of the invention is technologies associated with reconfigurable payload systems and methods, and in particular, systems and methods for providing intelligent electric vehicles with reconfigurable payload systems.

### BACKGROUND

The background description includes information that may be useful in understanding the present inventive subject matter. It is not an admission that any of the information provided herein is prior art or applicant admitted prior art, or relevant to the presently claimed inventive subject matter, or that any publication specifically or implicitly referenced is prior art or applicant admitted prior art.

With the dawn of widespread development and use of electric vehicles, there has also been diversification of specific markets for such vehicles from large cargo carrying trucks down to micro drones. One specific market area that has developed over the last several years includes the market for low-speed vehicles (LSVs), which typically include four-wheel electric vehicles having a top speed of about 25 to 35 miles per hour (about 40 to 56 kilometers per hour). LSVs have found many target use cases including last mile delivery, maintenance for campus, forestry, or other areas where there is no need for heavy or cumbersome traditional vehicles. However, even though LSVs are already environmentally sound (e.g., light weight, low to no fossil fuel emissions, low noise, etc.), they can still have significant negative environmental impacts. For example, a maintenance LSV might need to traverse a natural, unpaved area (e.g., a field, lawn, meadow, etc.). In such cases, the wheels of the vehicle still may rip up the natural terrain during acceleration, such as when power is engaged or when braking, which can damage the environment. Further, in areas where there are significant differences in terrain, possibly including slopes, pavement, lawn, etc., an operator of the LSV might engage power in a manner that is not environmentally sound for the local environment or in a manner that could even be dangerous given the local conditions.

Even though great strides have been made in electric vehicles, there remains a need to ensure electric vehicles have reduced impact on the environment in which they operate. Electric vehicles should ensure their operational parameters are constrained to protect the environment, while also being adjusted for local conditions, or managed to ensure safety of the operator or the vehicle itself. The following discussion describes the work of the inventor and gives rise to electric vehicles (e.g., LSVs, etc.) that are more ecologically sensitive while also retaining economical efficiencies or work-related performance.

### SUMMARY

The inventive subject matter provides apparatus, systems, and methods in which an electric vehicle is dynamically configured to have reduced impact on a real-world environment (e.g., forest, golf course, farm, campus, etc.). One example embodiment includes an environmentally low impact electric vehicle, which can comprise a set of sensors, at least one battery, and a vehicular controller. One or more batteries, preferably rechargeable or swappable batteries, provide power to the electric vehicle's various electrical elements. The set of sensors are coupled with the vehicular controller and provide information about the local environment of the vehicle. The sensors may further provide information about the environmental impact the vehicle has been making. Further, the set of sensors can cover a broad range of sensor modalities and can include accelerometers, gyroscopes, piezoelectric sensors, cameras, LIDAR, radar, GPS, sound detectors, electromagnetic field sensors, or other types of sensors. The vehicular controller comprises a computer readable memory and at least one processor and is further coupled with the set of sensors and the batteries for power.

The vehicular controller may be configurable to control the electric vehicle (e.g., controlling environmental impact cancellation systems, controlling associated components of the vehicle, adjusting the operational profile, etc.) to minimize residual environmental impacts of the vehicle based on various environmental information (e.g., determined from sensor data obtained from the set of sensors, provided by an operator, etc.). Such environmental information may include various types of environmental impacts created by the vehicle, the geo-location of the vehicle, a locally sensed context, any other suitable environmental data, and/or a combination thereof. More specifically, when the processor executes software instructions stored in the memory, the controller performs various operations including obtaining environmental data, obtaining environmental impact data from various environmental impact sensors (e.g., electromagnetic field sensors, sound/noise sensors, surface impact sensors, thermal sensors, cameras etc.) and obtaining location data from at least one location sensor (e.g., GPS, inertial measurement unit (IMU), visual location, etc.).

The controller's operations may further include receiving at least one operational profile (e.g., a torque profile), from a profile database. In various embodiments, the operational profile may be selected based on the environmental data, the payload system configuration, etc. In some embodiments, a neural network model and deep learning methods may be used to determine the operational profile for minimized environmental impact, e.g., based on the environmental data, the payload system configuration, etc. For example, the profile database could store operational profiles indexed based on geo-fences or geo-locations and can return such profiles in response to receiving a geo-location query. Additional operations include instantiating a local vehicle context in the memory based on local environment sensor data obtained from the sensors. Preferably, the local context provides a more fine-grained understanding of the environment around the vehicle. Thus, the operations can further include generating a set of operational instructions (e.g., wheel instructions, motor instructions, etc.) based on the operational profile, the local context, and payload system configuration. In more specific embodiments, a torque profile is adjusted based on the local context and the payload system configuration, and corresponding instructions are generated for the motors driving the wheels of the vehicle. Once the set of operational instructions are generated, the operations can further include executing the instructions to thereby cause the vehicle to take corresponding actions; motors causing the wheels to move according to a torque profile, for example.

The goal is to design and produce zero emission, tailorable, low speed vehicles that serve a plurality of purposes, with a high level of sustainability in every phase of vehicle design and operation. Various techniques and designs are implemented to achieve a vehicle that traverses its chosen environment without disturbing it, damaging it, or leaving minimal residual traces of having been there. Specifically, zero emission allows for vehicle use indoors, in highly congested environments, or in any application where emissions may affect the health or productivity of living beings. In an example, the weight of the vehicle is minimized while maximizing the contact patch and unique tire compounding to leave the surfaces traversed undamaged. In another example, a controller controls the vehicle (e.g., throttle response, brake response, other suitable responses, and/or a combination thereof) to minimize impact to the environment (e.g., by eliminating wheel spinning and the associated turf or soft surface disruption). In yet another example, payload subsystems of the vehicle are extraordinarily lightweight and highly reconfigurable (e.g., switched from a flatbed to a pickup bed to a boxbed or any suitable variation), allowing for different uses (e.g., resort use during the day, utility use at night, or tailored food deliveries that differ between the breakfast, lunch, and dinner hours). In that example, the controller controls the vehicle according to the different payload system configurations for minimizing impact to the traversed environment. In yet another example, to achieve a minimized surface impact, the controller controls the vehicle to use back tires to reduce or eliminate tire tracks of the front tires (e.g., where the back tires have tread patterns opposing the tread patterns of the front tires) based on the environmental data, including tire track data of the tire tracks created by the vehicle. In yet another example, to achieve a minimized electromagnetic environmental impact, the controller controls an electromagnetic impact cancellation system based on the environmental data, including electromagnetic environmental impact data of the electromagnetic environmental impact created by the vehicle. In yet another example, to achieve a minimized noise environmental impact, the controller controls a noise impact cancellation system based on the environmental data, including noise impact data of the noise impact created by the vehicle. In yet another example, to achieve a minimized thermal environmental impact, the controller controls a thermal impact cancellation system (e.g., with thermal management of external surfaces of the vehicle) based on the environmental data, including thermal impact data of the thermal impact created by the vehicle. In yet another example, to achieve a minimized visual environmental impact, the controller controls a visual cancellation system (e.g., with visual management of external surfaces of the vehicle to reflect or mirror the environment) based on the environmental data.

Embodiments of the invention are described by the claims that follow the description. In some embodiments, systems and methods for providing a reconfigurable payload system for an electric vehicle include determining a first payload configuration from a plurality of payload configurations based on a first payload capability requirement for the electric vehicle; providing the electric vehicle with the reconfigurable payload system configured with the first payload configuration; and controlling the electric vehicle with the first payload configuration to traverse a first area with a minimal environmental impact.

In some embodiments, determining the first payload configuration includes: determining the first payload configuration based on the first payload capability requirement and environmental data. In some embodiments, determining the first payload configuration includes: receiving a training dataset including a plurality of data samples, wherein each data sample each data sample is associated with a payload configuration of the plurality of payload configurations and associated environmental impact data; training a neural network model with the received training dataset with a loss function for minimizing the environmental impact; and providing, using the trained neural network model, the first payload configuration, based on the first payload capability requirement. In some embodiments, providing the electric vehicle with the reconfigurable payload system configured with the first payload configuration includes: connecting a first plurality of subcomponents to a payload base of the reconfigurable payload system based on the first payload configuration; or loading a payload pod preconfigured with the first payload configuration to a payload base of the reconfigurable payload system.

In some embodiments, the payload base includes slide-on or roll-on pallet structures with roller bases, slide bases, or structure locking pins. In some embodiments, the payload base includes a base plate, wherein the base plate is configured to lift, using a riser, to create a roll-on, roll-off cargo configuration. In some embodiments, the riser is configured to operate laterally to permit cargo roll-on, roll-off from either side laterally. In some embodiments, the payload pod is loaded, based on the first payload configuration, with a plurality of independently loadable bolt-on cargos, including seats, lavatories, galleys, sleep compartments, beverage systems, or tool stations/workstations.

In some embodiments, the reconfigurable payload system reconfigured with the first payload configuration includes: a plurality of base connectors selectively attachable to a payload base of the electric vehicle; and at least two modular wall structures attachable to the plurality of base connectors to form a payload structure at least partially enclosing the bed of the electric vehicle. The at least two modular wall structures comprising at least two of: a rigid wall panel selectively connectable with at least one base connector of the plurality of base connectors; or a rigid door selectively connectable with at least one base connector of the plurality of base connectors; or a rigid front cap or a rear cap selectively connectable with at least one base connector of the plurality of base connectors; or a rigid bed cover selectively connectable with at least one base connector of the plurality of base connectors.

In some embodiments, a second payload configuration from the plurality of payload configurations is determined based on a second payload capability requirement for the electric vehicle. The electric vehicle with the reconfigurable payload system configured with the second payload configuration is provided and controlled, such that the electric vehicle with the second payload configuration traverses a second area with a minimal environmental impact.

In some implementations, the present disclosure is directed to a reconfigurable payload structure for a bed of an electric low speed vehicle. The reconfigurable payload structure may include a plurality of bed arches selectively attachable to the bed of the electric low speed vehicle, and may include at least two modular wall structures attachable in a variety of configurations to the plurality of bed arches to form a payload structure at least partially enclosing the bed of the electric low speed vehicle. In some aspects, the at least two modular wall structures comprising at least two of a rigid wall panel selectively connectable with at least one bed arch of the plurality of bed arches, or a rigid door selectively connectable with at least one bed arch of the plurality of bed arches, or a rigid front cap or a rear cap selectively connectable with at least one bed arch of the plurality of bed arches, or a rigid bed cover selectively connectable with at least one bed arch of the plurality of bed arches.

In some aspects, each bed arch of the plurality of bed arches, the wall panel, the door, the front cap or the rear cap, and the at least one bed cover each have a thickness of less than about 12-inches in at least one direction. In some aspects, the bed arches comprise a base connector configured to couple with a connector of the LSV and secure the bed arch in a position spanning the bed of the LSV. In some aspects, each of the wall panel and the door comprises common fastening components configured to interchangeably connect to a bed arch of the plurality of bed arches.

In some example implementations, the present disclosure relates to a reconfigurable payload structure for a bed of an electric low speed vehicle that includes a plurality of bed arches attachable to the bed of the electric low speed vehicle. It may also include a plurality of wall panels selectively connectable with at least one bed arch of the plurality of bed arches in a manner forming a wall structure of the payload structure. A plurality of doors may be selectively connectable with at least one bed arch of the plurality of bed arches in a manner forming a wall structure of the payload structure. A plurality of front caps or rear caps may be selectively connectable with at least one bed arch of the plurality of bed arches in a manner forming a wall structure of the payload structure. At least one bed cover may be selectively connectable with at least one bed arch of the plurality of bed arches in a manner forming a cover over the bed of the electric low speed vehicle. Each wall panel of the plurality of wall panels, each door of the plurality of doors, each front cap or rear cap of the plurality of front caps or rear caps, and the at least one bed cover may be configured to be connectable in multiple configurations to form a customized payload structure at least partially enclosing the bed of the electric low speed vehicle.

In some aspects, each of the wall panels, each of the doors, each of the front caps or rear caps, and the at least one bed cover have a thickness of less than about 12-inches in at least one direction. In some aspects, at least two of the following are connected to form vertical or horizontal wall structures supported by at least one bed arch of the plurality of bed arches: a panel of the plurality of wall panels attached to a bed arch of the plurality of bed arches; a door of the plurality of doors attached to a bed arch of the plurality of bed arches; a front cap or rear cap of the plurality of front caps or rear caps attached to a bed arch of the plurality of bed arches; and the at least one bed cover attached to a bed arch of the plurality of bed arches. In some aspects, each of the wall panels and each of the doors have common fastening components configured to interchangeably connect to a bed arch of the plurality of bed arches.

In some example implementations, the present disclosure relates to a method of configuring a payload structure for an electrical low speed vehicle that may include selecting at least three payload structure components from the following payload structure components: a bed arch, a wall panel, a door, a front cap or a rear cap, and a bed cover; connecting a first of the selected payload structure components to the bed of the electric low speed vehicle; connecting a second of the selected payload structure components to the first selected payload structure of the electric low speed vehicle; and connecting a third of the selected payload structure components to at least one of the first selected payload structure components and the second selected payload structure components, to at least partially enclose the bed of the electric low speed vehicle.

In some aspects, the method may include: removing at least one of the first of the selected payload structure components, the second of the selected payload structure components, and the third of the selected payload structure components; and reconfiguring the payload structure by adding at least one more of the first of the selected payload structure components, second of the selected payload structure components, and the third of the selected payload structure component. In some aspects, the method may include loading the bed of the LSV with a container by utilizing bearings or rollers on the bed. In some aspects, the bearings or rollers accommodate lateral rolling.

In yet another implementation the present disclosure is directed to payload base pallet architecture that includes a payload base having a fastening system disposed thereon for attaching a preloaded pallet subsystem. The payload base pallet architecture may also include at least three different, modular, pre-loaded pallet subsystems attachable to the payload base, each of the at pre-loaded pallet subsystems sized so that at least two of the pre-loaded pallet subsystems simultaneously fit onto and are securable onto the payload base.

In some aspects, the pre-loaded pallet subsystems have a substantially the same area when loaded on the payload base. In some aspects, each of the at least three different at least three different, modular, pre-loaded pallet subsystems comprise one of seats, lavatories, galleys, sleep compartments, beverage systems, or tool stations/workstations. In some aspects, each of the at least three different, modular, pre-loaded pallet subsystems are independently removable from and independently securable onto the payload base.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 provides a schematic of an example environment with different types of terrain according to some embodiments.

FIG. 2 illustrates an example electric vehicle according to some embodiments.

FIG. 3 illustrates an example computer-based controller for an electric vehicle according to some embodiments.

FIG. 4 provides an example method of obtaining an operational profile for an electric vehicle according to some embodiments.

FIG. 5 provides an overview of a profile database and an operational profile for an electric vehicle according to some embodiments.

FIG. 6 illustrates example techniques for partitioning an environment based on terrain types according to some embodiments.

FIG. 7 outlines an example use of a local context for electric vehicle according to some embodiments.

FIG. 8 is a flowchart of an example method for providing and controlling an electric vehicle with a reconfigurable payload system according to some embodiments.

FIG. 9 illustrates an example payload configuration for a reconfigurable payload system according to some embodiments.

FIG. 10 illustrates another example payload configuration for a reconfigurable payload system according to some embodiments.

FIG. 11 illustrates yet another example payload configuration for a reconfigurable payload system according to some embodiments.

FIG. 12A illustrates an example payload base of a reconfigurable payload system according to some embodiments; FIG. 12B illustrates another example payload base of a reconfigurable payload system according to some embodiments; FIG. 12C illustrates yet another example payload base of a reconfigurable payload system according to some embodiments.

FIG. 13 illustrates yet another example payload configuration for a reconfigurable payload system according to some embodiments.

FIG. 14 illustrates yet another example payload configuration for a reconfigurable payload system according to some embodiments.

FIG. 15 illustrates yet another example payload configuration for a reconfigurable payload system according to some embodiments.

FIG. 16 illustrates yet another example payload configuration for a reconfigurable payload system according to some embodiments.

FIG. 17 illustrates yet another example payload configuration for a reconfigurable payload system according to some embodiments.

FIG. 18 illustrates yet another example payload configuration for a reconfigurable payload system according to some embodiments.

FIG. 19 illustrates yet another example payload configuration for a reconfigurable payload system according to some embodiments.

FIG. 20 illustrates yet another example payload configuration for a reconfigurable payload system according to some embodiments.

FIG. 21 illustrates yet another example payload configuration for a reconfigurable payload system according to some embodiments.

FIG. 22 illustrates yet another example payload configuration for a reconfigurable payload system according to some embodiments.

FIG. 23 illustrates yet another example payload configuration for a reconfigurable payload system according to some embodiments.

FIG. 24 illustrates yet another example payload configuration for a reconfigurable payload system according to some embodiments.

FIG. 25 illustrates yet another example payload configuration for a reconfigurable payload system according to some embodiments.

FIG. 26 illustrates yet another example payload configuration for a reconfigurable payload system according to some embodiments.

FIG. 27 illustrates yet another example payload configuration for a reconfigurable payload system according to some embodiments.

FIG. 28 illustrates yet another example payload configuration for a reconfigurable payload system according to some embodiments.

FIG. 29 illustrates yet another example payload configuration for a reconfigurable payload system according to some embodiments.

FIG. 30 illustrates yet another example payload configuration for a reconfigurable payload system according to some embodiments.

FIG. 31 illustrates yet another example payload configuration for a reconfigurable payload system according to some embodiments.

FIG. 32 is a flowchart of an example method for using neural network models and machine learning to provide and control an electric vehicle with a reconfigurable payload system according to some embodiments.

FIG. 33 is an illustration of a plurality of modular components usable to reconfigure a payload structure of the LSV according to some implementations of the present disclosure.

FIG. 34 is a flowchart of an example method for building and reconfiguring a reconfigurable payload system according to some embodiments.

FIG. 35 is an illustration of a payload base pallet architecture with modular preloaded pallet subsystems according to some embodiments.

### DETAILED DESCRIPTION

It should be noted that any language directed to a computer or computing device (e.g., a controller, etc.) should be read to include any suitable combination of computing devices, including servers, interfaces, systems, databases, agents, peers, engines, controllers, modules, or other types of computing devices operating individually or collectively. One should appreciate the computing devices comprise a processor configured to execute software instructions stored on a tangible, non-transitory computer readable storage medium or memory (e.g., hard drive, field-programmable gate array (FPGA), programmable logic array (PLA), solid state drive (SSD), random-access memory (RAM), flash, read-only memory (ROM), etc.). The software instructions configure or program the computing device to provide the roles, responsibilities, or other functionality as discussed below with respect to the disclosed apparatus. Further, the disclosed technologies can be embodied as a computer program product that includes a non-transitory computer readable medium storing the software instructions that causes a processor to execute the disclosed steps associated with implementations of computer-based algorithms, processes, methods, or other instructions. In some embodiments, the various servers, systems, databases, or interfaces exchange data using standardized protocols or algorithms, possibly based on Hypertext Transfer Protocol (HTTP), Hypertext Transfer Protocol Secure (HTTPS), Advanced Encryption Standard (AES), public-private key exchanges, web service application programming interfaces (APIs), known financial transaction protocols, or other electronic information exchanging methods. Data exchanges among devices can be conducted over a packet-switched network, the Internet, local area network (LAN), wide area network (WAN), virtual private network (VPN), or other type of packet switched network; a circuit switched network; cell switched network; or other type of network.

As used in the description herein and throughout the claims that follow, when a system, engine, server, device, module, or other computing element is described as configured to perform or execute functions on data in a memory, the meaning of “configured to” or “programmed to” is defined as one or more processors or cores of the computing element being programmed by a set of software instructions stored in the memory of the computing element to execute the set of functions on target data or data objects stored in the memory.

The inventive subject matter provides apparatus, systems, and methods in which an electric vehicle is dynamically configured to have reduced impact on a real-world environment (e.g., forest, golf course, farm, campus, etc.). One example embodiment includes an environmentally low impact electric vehicle, which can comprise a set of sensors, at least one battery, and a vehicular controller. One or more batteries, preferably rechargeable or swappable batteries, provide power to the electric vehicle's various electrical elements. The set of sensors are coupled with the vehicular controller and provide information about the local environment of the vehicle. Further, the set of sensors can cover a broad range of sensor modalities and can include accelerometers, gyroscopes, piezoelectric sensors, cameras, LIDAR, radar, GPS, sound detectors, electromagnetic field sensors, or other types of sensors. The vehicular controller comprises a computer readable memory and at least one processor and is further coupled with the set of sensors and the batteries for power. The vehicular controller is configurable to adjust the operational profile of the electric vehicle based on the geo-location of the vehicle as well as based on a locally sensed context determined from sensor data obtained from the set of sensors. More specifically, when the processor executes software instructions stored in the memory, the controller performs various operations including obtaining location data from at least one location sensor (e.g., GPS, inertial measurement unit (IMU), visual location, etc.). The controller's operations further include receiving at least one operational profile, typically a torque profile, from a profile database where the operational profile is selected based on the location data. For example, the profile database could store operational profiles indexed based on geo-fences or geo-locations and can return such profiles in response to receiving a geo-location query. Additional operations include instantiating a local vehicle context in the memory based on local environment sensor data obtained from the sensors. Preferably, the local context provides a more fine-grained understanding of the environment around the vehicle. Thus, the operations can further include generating a set of operational instructions (e.g., wheel instructions, motor instructions, etc.) based on the operational profile and the local context. In more specific embodiments, a torque profile is adjusted based on the local context and corresponding instructions are generated for the motors driving the wheels of the vehicle. Once the set of operational instructions are generated, the operations can further include executing the instructions to thereby cause the vehicle to take corresponding actions; motors causing the wheels to move according to a torque profile, for example.

The goal is to design and produce zero emission, tailorable, low speed vehicles with minimal environmental impacts that serve a plurality of purposes. Various techniques and designs are implemented to achieve a vehicle that traverses its chosen environment without disturbing it, damaging it, or leaving any residual traces of having been there. Specifically, zero emission allows for vehicle use indoors, in highly congested environments, or in any application where emissions may affect the health or productivity of living beings. In an example, the weight of the vehicle is minimized while maximizing the contact patch and unique tire compounding to leave the surfaces traversed undamaged. In another example, a controller (e.g., using a processor and software) controls the vehicle (e.g., throttle response, brake response, other suitable responses, and/or a combination thereof) to minimize impact to the environment (e.g., by eliminating wheel spinning and the associated turf or soft surface disruption). In yet another example, payload subsystems of the vehicle are extraordinarily lightweight and highly reconfigurable (e.g., switched from a flatbed to a pickup bed to a boxbed or any suitable variation), allowing for different uses (e.g., resort use during the day, utility use at night, or tailored food deliveries that differ between the breakfast, lunch, and dinner hours). In that example, the controller may control the vehicle according to the different payload system configurations for minimizing impact to the traversed environment.

As discussed in detail below, the disclosed techniques provide various advantageous technical effects for controlling the vehicle (e.g., dynamically adjusting the operational parameters of the vehicle, rotationally synchronizing the front and back wheels, etc.) to achieve a reduced impact on the environment while ensuring that the vehicle remains safe. An example advantage is controlling the vehicle based on various environmental data (e.g., environmental impacts created by the vehicle, its geolocation, its local environment, any other suitable environmental data, and/or a combination thereof) and vehicle configuration (e.g., payload configuration, tire patterns, etc.). Another example advantage is controlling a vehicle based on, a residual environmental impact created by the vehicle, e.g., after the controller performs environmental impact cancellation. Yet another example advantage is controlling a vehicle based on differences between residual environmental impacts resulted from different methods of environmental impact cancellation are performed.

In various embodiments, a vehicle can collect sensor data to determine environment data (e.g., environmental impacts created by the vehicle, nature of the local environment) around or near the vehicle. Various types of environmental impacts by the vehicle or components thereof may be determined, including for example, electromagnetic radiation impact (also referred to electromagnetic impacts), sound impacts (e.g., created by engine, horn, tire, etc.), emission impacts, surface impacts, thermal impacts, visual impacts, any other impact to the environment, and/or a combination thereof. The vehicle may collect such sensor data for each of the various types of environmental impacts created by the vehicle or components thereof, residual environmental impacts after the controller performs environmental impact cancellation, and combined environmental impacts as a whole. Furthermore, based on such data collected at different times, the effectiveness of environmental impact cancellation by the controller is determined (e.g., based on the differences of the environmental impacts before and after environmental impact cancellation), which enables the controller to adjust its environmental impact cancellation process to further reduce the residual environmental impacts.

The focus of the disclosed inventive subject matter is to enable construction or configuration of a computing device to operate on vast quantities of digital data, beyond the capabilities of a human. Although the digital data represents a local environment, it should be appreciated that the digital data is a representation of one or more digital models of the environment, not the natural environment itself. By instantiation of such digital models (e.g., a local vehicle context) in the memory of the computing devices (e.g., vehicular controller), the computing devices can manage the digital data or models in a manner that could provide utility to a user of the computing device that the user would lack without such a tool. Further, the disclosed vehicles can make fine-grained adjustments to their operational parameters based on local conditions far faster than a human could.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

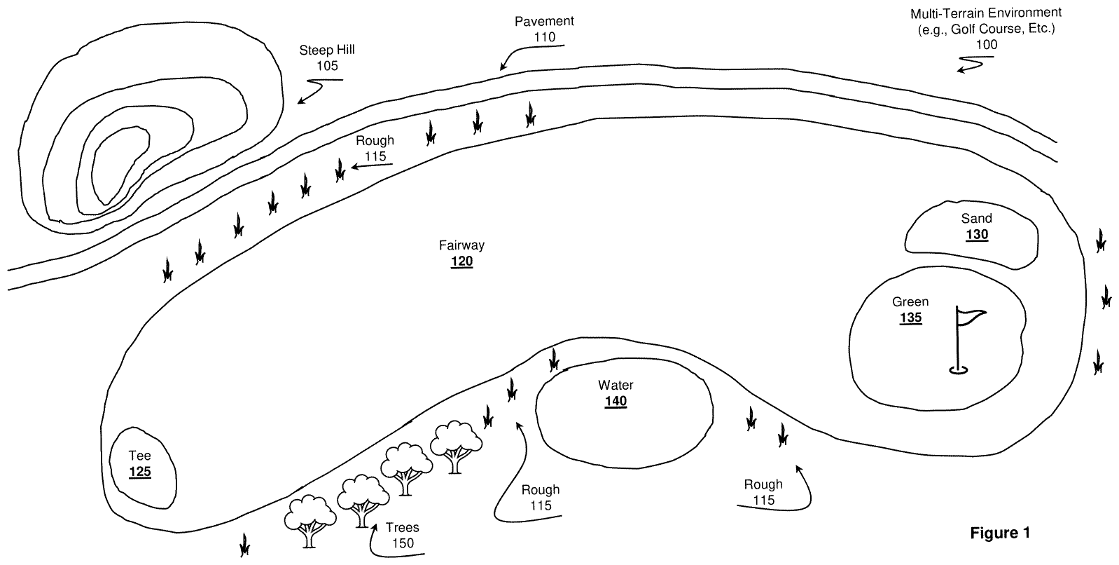

FIG. 1 presents multi-terrain environment 100 in the context of a golf course as a framework to describe the inventive subject matter. While FIG. 1 illustrates environment 100 as a golf course, one should appreciate the disclosed techniques are not so limited. Rather environment 100 could comprise any real-world or physical environment having a spectrum of terrain types. For example, other environments could include college campuses, apartment complexes, amusement parks, military bases, cities, city parks, natural parks, retirement communities, or other types of environments. Regardless, the disclosed electric LSV can be considered to operate in multi-terrain environment 100 in various capacities including operating as one or more of a maintenance vehicle, a refrigeration vehicle, a grounds keeping vehicle, a cargo carrying vehicle, a delivery vehicle, a pleasure vehicle, a personal transport vehicle, a bus, an emergency vehicle, an unmanned vehicle or drone, an autonomous vehicle, a robot, or operate according to other types of service requirements.

The LSV may encounter various types of terrain which can impact the operation of the vehicle. Further, in view of the differences of the terrains, the vehicle can cause a negative impact on the environment. Consider a scenario where the LSV must contend with the terrains in environment 100 and must adjust its operational parameters as the LSV moves in a single terrain or moves from one terrain to another as discussed below.

From a high-level perspective, the disclosed LSVs can adjust their operational parameters using operational profiles stored in a database where the profiles are indexed by relevant location data. The LSV, via a vehicular controller, can obtain the profile via submitting a location-based query to the database. Further the LSV can use sensor data from one or more sensors disposed on or about the vehicle to determine a local context. The controller uses the local context to make fine-grained adjustments to the operational profile (e.g., a torque profile as discussed below, etc.) to ensure the LSV has a further optimized performance relative to the impact on the environment. Again, the details of these high-level features will be discussed further below.

Returning to environment 100, consider a scenario where the LSV is operating in a golf course setting, possibly as a grounds-keeping vehicle. A golf course setting was selected for this illustrative example due to the varied terrain and sensitivity of the terrain to repeated use while juxtaposed against the need to keep the terrain in a playable or pleasing state. However, as referenced above, the disclosed issues associated with a golf course can be extrapolated to other settings.

Environment 100 may include one or more hills or other physical features as exemplified by steep hill 105. Hill 105 may have one or more specific features that could impact the operation of the LSV. For example, hill 105 might simply be inaccessible according to an operational profile, thus the vehicle may be restricted or forbidden to operate on hill 105 or forbidden to approach a buffer area around hill 105. Such restrictions may be of use in cases where the vehicle or passengers may be at risk or to protect the natural environment (e.g., flora, fauna, prevent erosion, etc.), possibly in a nature park or nature reserve. Still, hill 105 could also remain accessible, although it might have specific features that must be accounted for; possibly including a steep slope as illustrated by the dense contours of hill 105. In such cases, the operational profile associated with the hill 105 can include commands that ensure the LSV can maintain stability on the slope, or other specific feature, or that also ensure the LSV doesn't damage the slope. More specifically, the LSV could be instructed to adjust tire pressure or torque so the wheels of the LSV roll without slipping or could be instructed to restrict movement along specific or defined paths on the slope wherein the paths are known to have the best approach for going up the slope or down the slope. Even further, the operational profiles associated with hill 105 can further include speed or velocity (i.e., speed and direction) restrictions on or around hill 105. One should appreciate that the operational profiles offer multiple advantages including one or more of the following: reduced impact on the environment, increased safety to passengers (e.g., tighten seat belt, reduce tilt, etc.), reduce risk to the vehicle itself and thereby increase cost savings (e.g., reduced maintenance, reduced replacements, reduced insurance costs, etc.), or increased management oversight.

While hill 105 might have operational profiles that result in reduced impact on the terrain in and around hill 105, pavement 110 might have operational profiles that are less restrictive. Pavement 110 can be considered a man-made terrain, for example, that is specifically configured to permit LSV to traverse an area with ease or without significantly impacting the environment. In the example shown, pavement 110 could include a cart path, but also could include a sidewalk, a street, a tennis court, or other type of prepared surface. For the sake of discussion, the operational profile associated with pavement 110 might be configured to permit LSV to operate as its full operational potential and may therefore not include restrictions. However, it is also possible the operational profile could restrict speeds to acceptable speed limits if desired. In a practical sense, while operating under the operational profile of pavement 110, the LSV could apply full torque from one or more motors to the wheels of the LSV or could achieve highest practical speeds, typically in the 25 mph to 35 mph range for most target use cases. While the disclosed vehicles are LSVs, it should be appreciated that other electric vehicles might not have such restrictions and might be permitted to operate in a higher capacity possibly limited only by their designs (e.g., road legal electric vehicles, electric trucks, drones, autonomous vehicles, boats, etc.).

While pavement 110 is considered paved, other types of vehicle corridors could also be present in environment 100, possibly including dirt roads, gravel roads, trails, or other types of prepared terrains. In such cases, the operational profiles for such prepared corridors can be adjusted accordingly to account for the differences in features. For example, a dirt road or gravel road might have operational profiles similar to pavement 110 but might restrict the torque applied to wheels to prevent rolling with slipping to reduce an amount of dust kicked up or to otherwise reduce the risk of disturbing environment 100. However, once rolling is achieved, the top speeds might not be restricted to permit the LSV to proceed to its destination in a timely fashion. Thus, operational profiles might be required to balance the need for operational goals relative to the desired to have reduced impact on environment 100.

Rough 115 represents yet another type of terrain that may be accounted for when creating operational profiles. While the rough of a golf course might simply include tall grass, it is possible rough 115 might have other attributes that influence corresponding operational profiles. More specifically, rough 115 could include flora or fauna that should be protected while also permitting the LSV to pass through. This gives rise to an interesting feature of the disclosed subject matter where multiple LSVs must be managed in aggregate rather than merely individually. For example, the operational profiles of rough 115 might permit a first LSV to pass through rough 115 along a specified path per unit time (e.g., per hour, per day, per week, per month, etc.), while a second LSV would be restricted from following the same path but would be permitted to traverse rough 115 along a second, different path. Such approaches are advantageous because the LSV retains access to the terrain, but also the terrain is permitted to recover after use. Thus, the operational profiles can be constructed to account for wear-leveling a terrain.

Turning toward fairway 120, fairway 120 can also have yet another set of operational profiles that differ from the other terrains. Fairway 120 is presented as an example of a “natural” (e.g., lawn, grass, etc.) terrain that may be prepared for use, but still should be protected to some degree. In some scenarios, the operational profiles of fairway 120 could also account for wear-leveling. In addition, the operational profiles might include restrictions based on max speed to reduce chances of collisions with other vehicles, people, or wildlife sharing the terrain. Still further, the operational profiles might also include proximity restrictions to simply forbid LSVs from sharing the same physical space, subject to buffer zones as desired. Rolling without slipping via torque control may also be an important feature of the operational profiles for fairway 120 to reduce the risk of the wheels of the LSV ripping the turf.

Tee 125 is presented as an example area that maybe small or possibly have a relatively high density of people present. In such examples, the corresponding operational profiles may have many of the various features already discussed, but might have further adjustments to account for features of the area. For example, in view the area might have a high density of people, the operational profile might limit the max speed to ensure the operators have time to react to the people present. Further, the number of vehicles permitted in the area might be restricted. Consider a scenario where the LSV is operating as a golf cart. The operational profiles for tee 125 could restrict the max speed to 2 mph, for example, and only allow two carts on the tee at the same time to account for a single party of golfers to be present on the tee at a time. In view of tee 125 can be considered a small area, restricting the max speed does not necessarily impact the utility of the vehicle in the area as an operator can traverse the area quickly. Further restricting the number of LSVs in the area can also be considered wear leveling.

Sand 130, illustrated as a sand trap, represents yet another type of terrain having interesting features that can be accounted for. Sand 130 could be similar in nature to the dirt or gravel roads mentioned above where the material of the terrain is loose, which may require the operational profiles to ensure the LSV moves by rolling without slipping as governed by a corresponding torque profile. Beyond controlling the wheel movements relative to the terrain, the operational profile could also include instructions to adjust other features of the LSV. For example, in some embodiments, the operational profile could also adjust the tire pressure of the LSV. As the LSV enters the area of sand 130, the LSV could reduce the tire pressure of the LSV's tires so that the tires have better traction while also operating under a rolling without slipping torque profile. In addition to or alternatively, as the LSV leaves the area of sand 130, the tire pressure could be increased to ensure the LSV, assuming the LSV is provisioned with self-inflating tires and/or corresponding pumps, operates with improved efficiency on the new terrain (e.g., fairway 120, pavement 110, etc.). Thus, one should appreciate the operational profiles can comprise features beyond controlling the motors or motion of the wheels of the LSV and can include operational parameters in or about the LSV.

In various embodiments, adjusting operational parameters including tire pressure also gives rise to purpose-built equipment that can be quite complementary to the disclosed inventive subject matter. To continue with the tire pressure example, altering the tire pressure to suite the environment can also impact the features of the tire itself beyond just the pressure itself. For example, changing the pressure could also change the shape of the tire to suit the environment. With respect to low pressure, tires such as System 3 Off-Road 32×12-15 System 3 Offroad SS360 Sand/Snow Bias Rear Tire would have better performance in snow or sand when the pressure is lower by adapting such tires to change shape or to increase the number of treads or paddles capable of engaging the loose contact surface. From a high-pressure perspective, tires such as Proline 1014613 Sling Shot MX43 Pro-Loc Tires could have fins or wings that expand out as pressure is increased. At even higher pressures, tires can be constructed so that studs (e.g., metal, rubber, etc.) or other features can emerge from between the treads when the pressure increase beyond a threshold. Thus, the pressure activated studded tires for the LSV would provide further traction, possibly on slippery, wet, snowy, or icy surfaces. An example of such a tire that could be suitably adapted for such a purpose includes the CST Sandblast Rear Tire 32×12-15 (15 Paddle) for Polaris RANGER RZR XP TURBO S 2018. Thus, the inventive subject matter is considered to include adapting tires, or other elements of the LSV, to be responsive or complementary to adjusting the operational parameters of the LSV due to the local environment.

While sand 130 may also have operational profiles similar to those discussed above including area restrictions or limitations, rolling without slipping instructions, speed restrictions, or other features, the nature of sand 130 could vary dramatically based on local or temporal conditions. For example, sand 130 might be dry, which may require speed or torque control as discussed above to reduce rolling without slipping. However, sand 130 may also be wet, possibly after maintenance or rain. In which case, the sand 130 may behave more like pavement 110 with respect to the performance of the LSV. The varied nature of the terrain under various local or temporal conditions give rise to the need for more fine-grained control as discussed further below.

Green 135 could be considered similar to fairway 120 or tee 125. However, green 135 represents an area that requires a high degree of care or expense to keep the area in a pristine state. Thus, green 135 could comprise operational profiles that simply exclude LSVs from entering the area. However, green 135 might also include operational profiles that function based on the nature of the LSV. Said differently, the attributes of the LSV may be used to determine which operational profile should be used in conjunction with the area. For example, if the LSV is a golf cart, the operational profile may simply exclude the LSV from entering the area. However, if the LSV is a grounds-keeping vehicle, the LSV may be permitted to enter the area with reduce tire pressure to increase the contact surface area of the wheels to thereby reduce the pressure of the vehicle on the terrain and reduce the impressions made in the terrain. In some embodiments, the LSV could be a lawn mower used to maintain the area.

Water 140, similar to sand 130, is illustrated as a hazard. In the golf course context, a LSV would be restricted from approaching water 140 to closely. However, it is also contemplated that other types of vehicles (e.g., drones, autonomous vehicles, lawn mowers, boats, etc.) might be permitted to approach the area in and around water 140. Additionally, water 140 also provides an illustrative example of an area having features not yet discussed. More specifically, the area around water 140 could comprise a flood plain, which may become critical during or after rain. For example, during or after rain the features around water 140 or other terrains around environment 100, might change due to flooding; for example, overflowing creeks and bridges could become impassible, or experience other changes. In which case, the LSV could alter the restriction requirement of the operational profiles to further restrict the LSV from entering the area. Alternatively, if water 140 could be covered in ice, in which case water 140 could have a corresponding operational profile permitting the LSV to operate on the ice. If emergency conditions exist, the operational profiles could include instructions the define permitted paths to safety. Still further, water 140 could have other conditions that could be important to one or more vehicles. Other local conditions could include waves, choppiness, water depths, or other conditions. Examples of water 140 could include a pond, water hazard, lake, ocean, beach, river, creek, stream, pool, or other type of body of water.

Trees 150 are also presented as an additional terrain having interesting features. Trees 150 represents an area that may be passible by LSV, but could have tight spaces which could cause maneuvering to be difficult. In such cases, the operational profile for the terrain of trees 150 to restrict the speed of LSV to reduce risk of impact with one or more trees. Further, having reduced speed, possibly rolling without slipping, will have a reduced impact of the natural environment around the trees. Additionally, in view the spaces where LSV may operate safely are difficult to find, the corresponding operational profiles can include one or more pre-programmed path that permit the operator to navigate the environment. Additional examples of restrictions that could apply in and around trees 150 include restricting turn radius, preventing the LSV from going in reverse, permit only service vehicles, permit only authorized operators in the area, or other features.

While environment 100 is mainly shown as a static environment, one should appreciate environment 100 could be quite dynamic as alluded to above. Thus, the shapes or features of environment 100 could change with time, weather conditions, natural events, man-made events, or other factors. Consider a case where the weather changes from clear to rainy. Pavement 110 might exhibit a significant change in friction, shift from a from dry, high friction terrain to a wet, low friction terrain. Thus, the corresponding operational profile might need updated. Alternatively, more than one operational profile could be obtained from which the LSV selects the most appropriate.

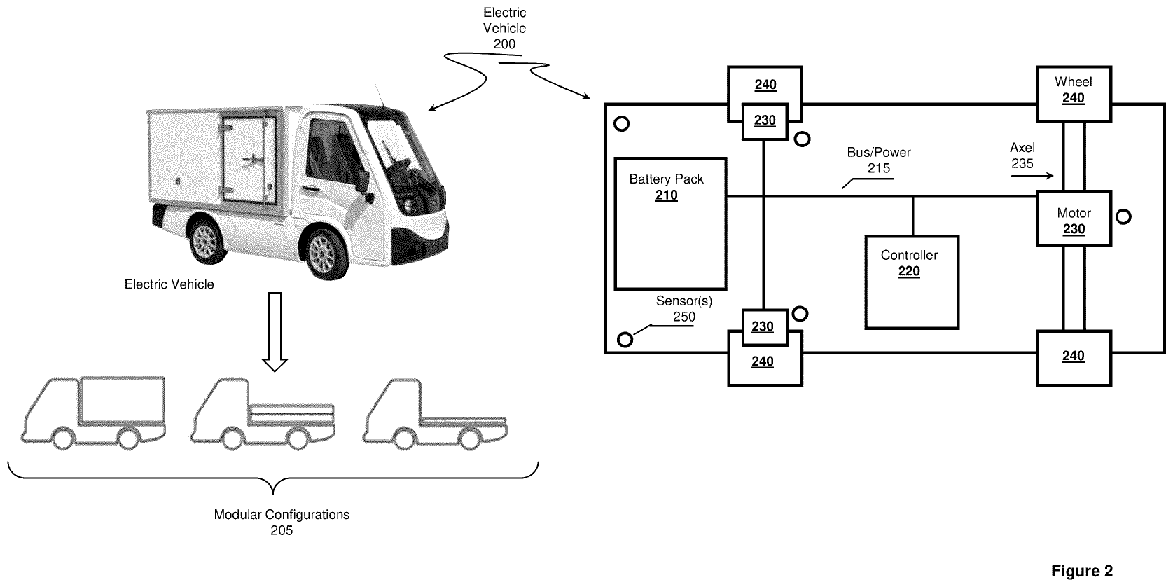

Environment 100 is illustrated as a single hole of a golf course. Still, one should appreciate the target working environment of an LSV could vary in size, dimensions, elevation, or other factors. For example, environment 100 could be defined based on political boundaries (e.g., zip codes, cities, etc.), geo-fenced boundaries, S2 cells, or other types of boundaries where the encompassed area could include a single type of terrain to many types of terrains (e.g., 2, 5, 10, 100, or more terrains). Of particular note, environment 100 could comprise a larger number of neighboring terrains similar to the terrains in environment 100. In such cases, the operational profiles can include rules or instructions by which the LSV should shift from deployment of one operational profile to another. Such transition rules can be considered to form an impedance match between terrains, which could include deceleration instructions, tire pressure changes, or other types of shifts in the operational profiles.

Where FIG. 1 presents a high-level overview of a potential operating environment for and LSV, FIG. 2 provides a more detailed discussion of an LSV. LSV 200 represents an acceptable electric low speed vehicle embodiment for use with the disclosure inventive subject matter. Example acceptable LSV 200 includes the Ayro, Inc. Club Car Current (see URL www.ayro.com/club-car-current), which is currently on the market at the time of this writing. LSV 200 is illustrated as a four-wheel vehicle. However, any practical number of wheels is also contemplated; two wheels (e.g., cycle configuration), three wheels (e.g., trike, etc.), and so on.

LSV 200 comprises one or more module configuration 205 permitting LSV 200 to change its target purpose. Module configurations 205 can be considered to change the nature of LSV 200, which in turn can change which operational profiles are of most relevance, possibly based on the attributes of LSV 200. For example, in a flatbed configuration LSV 200 could be operating as a grounds keeping vehicle. In which case, LSV 200 may be permitted to operate in natural terrains; lawns, fairways, forest, or other natural terrains for example. However, in a cargo configuration, LSV 200 could be operating in a delivery capacity. In which case, the corresponding operational profiles may permit LSV 200 to operate at higher speeds, but only on paved surfaces.

In more preferred embodiments LSV 200 operates as a battery-powered electric vehicle. LSV 200 comprises at least one battery as represented by battery pack 210. Battery pack 210 can comprise one or more rechargeable battery (e.g., Li-ion, Li-polymer, Li—S, etc.). Further, in some embodiments, battery pack 210 could comprise one or more swappable batteries to facilitate getting LSV 200 back in operation after a battery has drained. LSV further comprises a set of sensors 250 as represented by the small circles in FIG. 2. While sensors 250 are illustrated disposed on or about LSV 200, the inventive subject matter is not so restricted. Rather, sensor 250 could be deployed remotely. Further sensor data could be obtained from any local or remote source (e.g., weather prediction, news events, etc.). Especially preferred sensors include at least one location sensor; a GPS unit for example. Still other types of location sensors could comprise image-based sensor, IMUs, wireless triangulation units, cellular network location units, or other types of location sensors. LSV 200 further includes a set of controllable wheels 240 that are mechanically coupled with at least one controllable motor 230, which in turn is electrically coupled with battery pack 210.

LSV 200 presents various configurations of wheels 240 and motors 230 for discussion purposes. In some embodiments, each of wheel 240 could have a dedicated motor 230 in a manner that permits each wheel 240 to operate individually, but also collectively under instructions of vehicular controller 220. Still, in other embodiments, a single motor 230 could couple to more than one wheel 240. For example, a single motor 230 could couple to an axel of LSV supporting two or more wheels where motor 230 cause wheels 240 to rotate via a drive train. Thus, it should be appreciated that wheels 240 rotate in response to engagement of one or more of motors 230. LSV 200 further comprises one or more vehicular controller 220, which provides instructions to motors 230 or wheels 240 as well as governs other operational parameters of LSV 200.

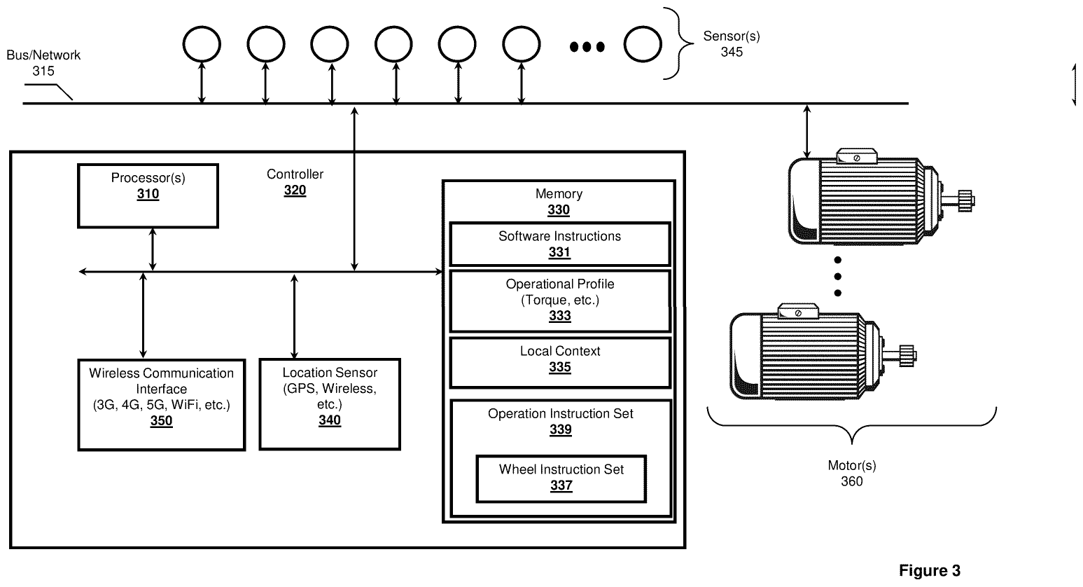

FIG. 3 provides additional information regarding a vehicular controller of contemplated LSVs. Controller 320 comprises a computing device having at least one computer readable memory 330 (e.g., RAM, ROM, flash, SSD, hard disk drive (HDD), etc.) storing software instructions 331 that configure the controller to take the actions described herein. Controller 320 further comprises one or more of processor 310 that execute the software instructions 331. In some embodiments, controller 320 could comprise one or more off the shelf single board computers (e.g., Raspberry Pi, Arduino, PC-104, etc.) or a dedicated computing device. Controller 320 further communicatively couples to a set of sensors 345, which may be disposed about the LSV. For example, sensors 345 could be coupled with controller 320 via one or more buses or network 315 (e.g., Universal Serial Bus (USB), wireless USB (WUSB), BlueTooth, controller area network (CAN), LAN, WiFi, etc.). Further, controller 320 can couple with one or more of motors 360, which in turn couple with the wheels of the LSV. As controller 320 executes its actions it can instruct or control motors to take corresponding actions (e.g., increase torque, turn on, turn off, decrease torque, forward, reverse, etc.). While motors 360 are illustrated as coupling with vehicular controller 320 over bus/network 315, motors 360 could couple to controller 320 over a separate connection or could couple via individual connections. For example, motors 360 could couple directly to controller 320 via connectors (e.g., pulse-width modulation (PWM), etc.) while power is supplied from the battery of the LSV.

Sensors 345 represent a broad spectrum of sensors capable of providing sensor data to controller 320 where the sensor data reflects the local conditions of the LSV or related to the LSV. Example sensors include, but are not necessarily limited to, one or more of the following sensors: an accelerometer, a magnetometer, a piezoelectric sensor, a microphone, a camera, a fluid sensor, an optic sensor, a hall effect sensor, a capacitance sensor, a resistivity sensor, a proximity sensor, a radio detection and ranging (RADAR) sensor, a light detection and ranging (LIDAR) sensor, turning or turning radius sensor, tilt sensor, or other type of sensor. Although the plurality of sensors 345 are illustrates, in general, as being disposed on, in, or about the LSV, in some embodiments, one or more of sensors 345 could be a remote sensor or a remote source of sensor data. For example, a remote source of sensor data could comprise a web service that provides weather information or weather predictions. Further, sensors could be active or passive. Active sensors can continuously provide sensor input to controller 320 while a passive sensor might only provide input to controller upon request.

As can be appreciated from the broad spectrum of possible sensors 345, the corresponding sensor data can cover a broad spectrum of data modalities. Said in a different way, the sensor data can represent a wide variety of local conditions. Controller 320 can compile the sensor data, which may be a direct measure of the local environment (e.g., a temperature, a pressure, etc.) or may be an indirect measure of the local environment (e.g., a resistance, a capacitance, etc.), into local environment data reflecting the local conditions in which the LSV is currently operating or might be operating in the near future as it moves about the environment or as time changes. Example types of local environmental data can include, but is not limited to, weather data, precipitation data, friction data, temperature data, time data, audio data, image data, pressure data, tilt data, weight data, acceleration data, video data, image data, or other type of data about the environment.

Location sensor 340 is explicitly called out as it has a special purpose with respect to the disclosed subject matter. Location sensor 340 provides controller 320 location data associated with the LSV. Typically, the location data comprises a current location of the LSV in the operating environment. However, it some embodiments, controller 320 can calculate a possible future location of the LSV by deriving one or more predicted values based on the movement, speed, direction, or other movement attributes of the LSV. More preferred location sensors 340 can include a Global Positioning System (GPS) unit. However, other types of sensors can also be leveraged to determine a location of the LSV in the environment. For example, the LSV could use image data or video data to determine its location via one or more implementations of image processing algorithms (e.g., simultaneous localization and mapping (SLAM), visual SLAM (vSLAM), neural networks, etc.) or recognition algorithms (e.g., QR codes, bar codes, markers, optical character recognition (OCR), etc.) where the environment has been provisioned with recognizable markers. Still further, the LSV could leverage wireless triangulation to determine its location based on one or more wireless transmitters (e.g., cell towers, beacons, etc.).

While location sensor is illustrated as being deployed on controller 320 or on LSV, in some embodiments location sensor 340 could be remote as well. In such cases, the location data from location sensor 340 could be obtained by controller 320 over a network possibly via wireless communication interface 350. More specifically, an environment could leverage locally deployed cameras (e.g., security cameras, etc.), which can provide a video feed to a central server, which reports on an observed location of the LSV.

The location data associated with the LSV could take on different forms. In some embodiments, the location data could comprise a local coordinate within the operating environment, possibly an address or a specific local coordinate for the environment's custom coordinate system. Still in other embodiments, the location data could comprise a geo-location representing a wide area location relative to a broader location beyond just the local environment or represent a world-wide geo-location (e.g., longitude, latitude, S2 cell identifier, etc.). Thus, the geo-location could comprise a GPS coordinate or other form of global position coordinate. Regardless, controller 320 leverages the location data to obtain one or more operational profiles for the LSV.

Memory 330 stores one or more sets of software instructions 331, which could take on different forms as well. Software instructions 331 could comprise executable binary code, which is compiled from a high-level language (e.g., C, C++, C#, etc.) and downloaded to memory 330, possibly via wireless communication interface 350. Further, software instructions 331 could also be implemented as a script or program from an interpreted language (e.g., python, Java, perl, etc.). In more preferred embodiments software instructions can be replaced, upgraded, modified or otherwise changed in the field via wireless communication interface 350 once suitable permission or security measures are in place.

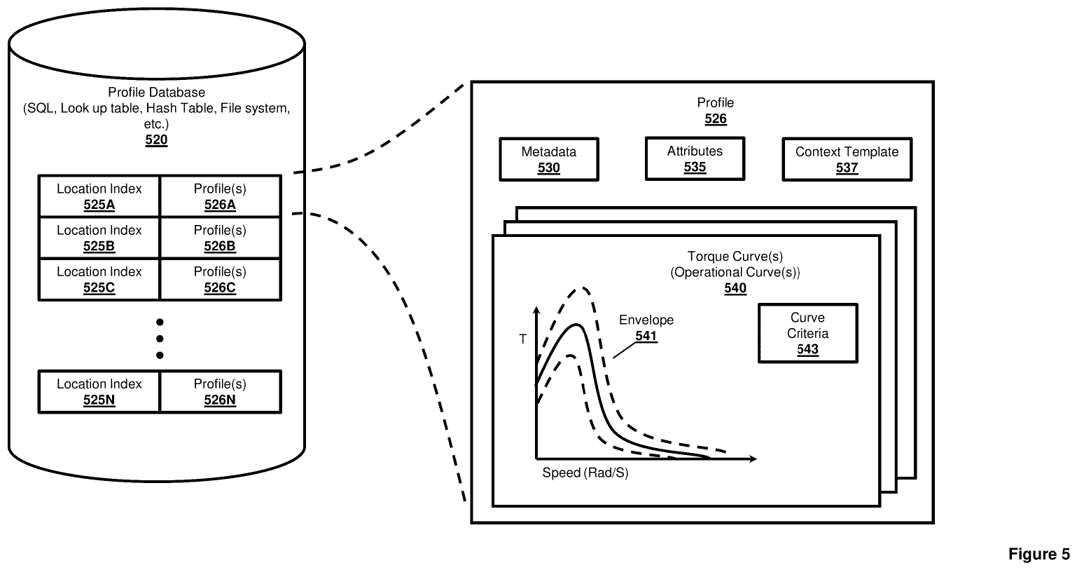

Beyond software instructions 331, memory 330 can also store other data structures or assets of use by controller 320. More specifically, memory 330 can store one or more of operational profile 333 retrieved from an operational profile database. For example, as the LSV travels around the environment, controller 320 can query the operational profile database using the location data obtained from location sensor 340. In response, controller 320 receives one or more corresponding operational profiles 333 relevant for the location. In response, controller 320 instantiates operational profile 333 in memory 330. As the LSV continues to operate in the environment, controller 320 enforces the rules, criteria, conditions, requirements, or other features of operational profile 333. Especially preferred operational profiles comprise a torque profile that governs the behaviors of motors 360 and thereby the contact surfaces of the LSV (e.g., wheels, etc.), which will be discussed in more detail with respect to FIG. 5.

Memory 330 also stores one or more of an instantiated local vehicle context 335. Context 335 represents the local conditions immediately around the LSV, which could be used by controller 320 to adjust the how the LSV operates according to the operational profile 333. Local context 335 comprises information compiled from the environmental data obtained or derived from the sensor data. Local context 335 does not necessarily need to include the actual environmental data, it could include the environmental data for bookkeeping reasons. Still, local context 335 leverages the environmental conditions to determine the fine-grained adjustments to make to operational profile 333.

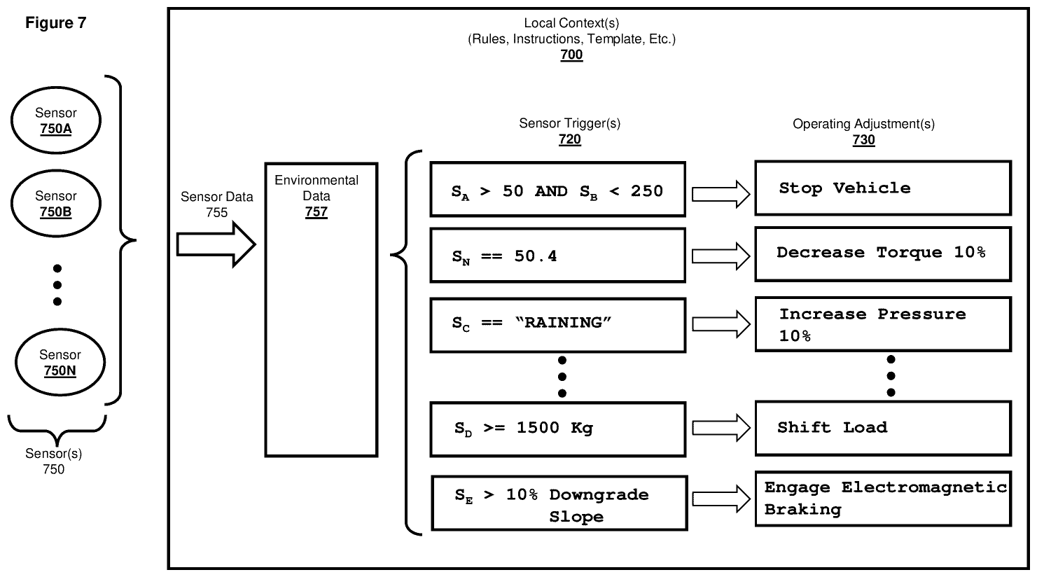

In some embodiments, local context 335 can be manifested from information stored in operational profile 333. For example, operational profile 333 can include a set of permitted adjustments and corresponding local condition criteria according to which such adjustments are triggered. A permitted adjustment could be represented digitally according to one or more digital formats possibly including Extensible Markup Language (XML), YMAL, JavaScript Object Notation (JSON), binary, script, table, or another digital format. As local conditions are sensed, the corresponding digital representation of the local context 335 can be updated. Additional details of local context 335 will be discussed with respect to FIG. 7.

Memory 330 further stores wheel instruction set 337, which comprises a set of wheel instructions on how to control the contact surfaces of the LSV via one or more of motors 360. Depending on the nature of the implementation, instructions 337 could comprise high level APIs through which controller 320 generates desired actions or could include low level instructions (e.g., setting values of registers that impact a PWM, etc.) causing motors 360 to take corresponding actions and, again, affecting the contact surfaces (e.g., tires, etc.) of the LSV.

One should appreciate the above discussion refers to the wheels of the LSV, while other forms of contact surfaces or modes of motion are also contemplated. The term “wheel” is used for the sake of discussion and the sake of consistency with respect to the main example use case. However, it should be noted that motors 360 could be coupled with many other forms of locomotion besides wheels depending on the nature of the electric vehicle. For example, in the case of a boat or ship, motors 360 may be coupled with a propeller, an impeller, a fin, a sail, or other forms of water-based locomotion. Further, in the case of an aerial vehicle (e.g., manned vehicle, unmanned vehicle, etc.), motors 360 may be coupled with a propeller, a ducted fan, a wing, a control surface, or other form of aerial control. Thus, wheel instruction set 337 can be generalized and considered to represent a set of instructions targeting motors 360, which in turn operate on controllable elements of the vehicle. Such more generalized instructions are euphemistically represented by operation instruction set 339. Therefore, in some embodiments, wheel instruction set 337 can be considered a subset of operation instruction set 339. Still, operation instruction set 339 can include instructions beyond controlling motors 360, possibly including shifting weight of a payload, controlling tire pressure, controlling air conditioning, controlling wipers, controlling orientation (e.g., pitch, yaw, roll, angle of attack, etc.), or other type of control.

The elements stored in or otherwise instantiated in memory 330 are not necessarily static data structures but could also comprise dynamic features. Each element, in more preferred embodiments, may be permitted to change in real time as controller 320 observes its local environment or receives information from a remote server. Therefore, the values in the corresponding data structures could change or the elements could comprise executable codes that could change, possibly including swapping out executable modules, changing which APIs are called, or other forms of changes.

Further the elements stored in memory also provide an initial overview of a flow of operations performed by controller 320. For example, controller 320 is provisioned with one or more of software instructions 331 by which controller 320 functions. Controller 320 obtains location data from location sensor 340 and uses the location data to retrieve one or more operational profiles (e.g., a torque profile, etc.) from a profile database. Controller 320 further observes the local conditions via sensors 345 and creates local context 335 based on the environmental data obtained from sensors 345. Controller 320 could then create operation instruction set 339, including wheel instruction set 337. Controller 320 could then execute the operational instructions, preferably in real time, to enable motors 360 to take corresponding actions (e.g., cause wheels to turn, etc.).

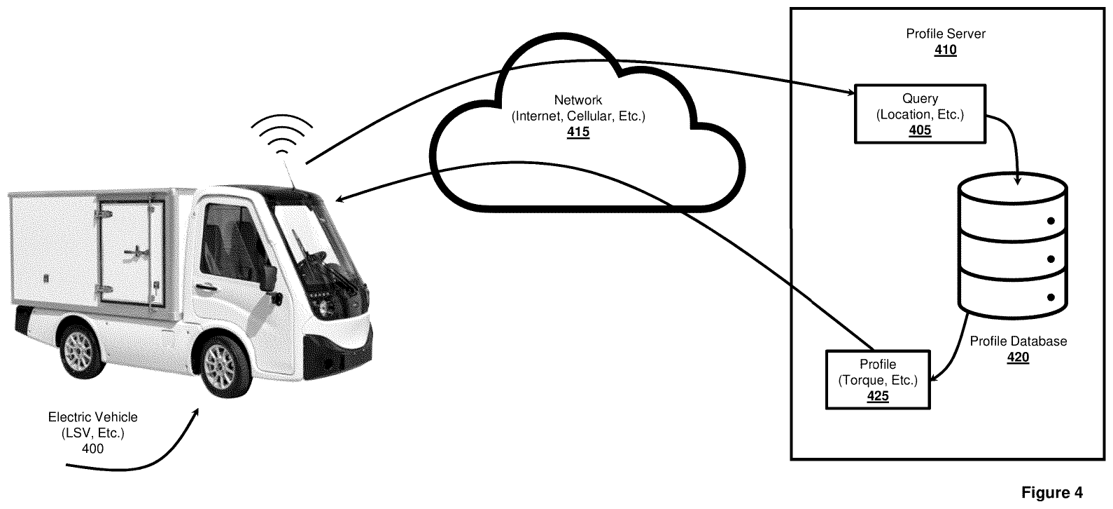

FIG. 4 illustrates a possible approach by which LSV 400 is able to retrieve an operational profile 425 from profile database 420. Operational profile 425 may typically comprises one or more of a torque profile by which the LSV vehicular controller generates commands for the motors of the LSV. Still, operational profile 425 may also include other forms of operational capabilities beyond motor control.

In the example shown, LSV 400 obtains location data from at least one location sensor, where the location data could be digitally encoded in different ways. For example, the location data could comprise geo-location coordinates, addresses, Google Plus codes (see URL maps.google.com/pluscodes), S2 cell identifiers, geo-fence identifiers, zip codes, or other forms of location data. LSV 400 can package the location data as a query targeting the index schema of profile database 420, possibly operating within profile server 410 remotely over network 415. In the example illustrated, LSV 400 generates query 405 and transmits the query over network 415 to profile server 410, possibly over a cellular network. In response, profile server 410 receives query 405 and, assuming authorization or permission is granted to LSV 400, submits a corresponding query to profile database 420. Note, the query submitted to profile database could be an unaltered form of query 405. However, it is also possible server 410 might translate or transform query 405 to a format understandable by profile database 420. Profile database 420 searches for records that have been indexed in a manner that satisfy query 405, especially satisfying the location data requirements in the query. Once one or more records comprising operational profiles 425 have been found, the corresponding operational profiles 425 can be transmitted back to LSV 400 over network 415.

While query 405 could comprise only the location data, it is also possible query 405 could comprise other information about the LSV as well, which may be used to further refine the result set from profile database 420. For example, query 405 could further include an identifier of the operator of the LSV, where the identifier can be used to obtain operational profiles to which the operator is permitted to use. Such an approach may be advantageous for insurance reasons, training reasons, safety reasons, or other purposes. Further, query 405 could comprise a set of LSV attributes describing the nature of the LSV's purpose. Example attributes could include a current configuration of the LSV (see modular configurations of FIG. 2), a current purpose of the LSV, an LSV identifier, a date or timestamp (e.g., age of LSV, date of manufacture, etc.), a current condition of the LSV (e.g., battery charge level, wear and tear indications, etc.), or other LSV information. Such additional query conditions, beyond the location data, aid in further refining the result set and thereby controlling the use of LSV 400.

While profile server 410 and profile database 420 are illustrated, more or less, as a cloud-based infrastructure, is should be appreciated that other forms of infrastructure are also possible. For example, LSV 400 could have a local profile repository that could be consulted without requiring communicating over network 415. In such cases, the vehicular controller of LSV 400 could operate as profile server 410 or profile database 420. Such cases are useful when LSV 400 is operating in a single, well-defined environment or operating in remote, unconnected locations. Still further, profile server 410 or profile database 420 could be shared among multiple versions of LSV 400. In which case, each LSV 400 could be a peer in a peer-to-peer network, where each LSV 400 could operate as the server or database for others via a local network (e.g., ad-hoc, P2P, mesh, LAN, WAN, etc.).

FIG. 5 presents a more detailed view of operational profiles that can be leveraged by the disclosed LSVs. Profile database 520 represents a data store housing one or more of operational profiles 526A through 526N, collectively referred to as profiles 526. Each profile in profiles 526 is preferably indexed by one or more of location index 525A through 525N, collectively referred to as indices 525. Profile database 520 can store profiles 526 in many different ways. Still, in more preferred embodiments, each profile of profiles 526 can be retrieved based on a location-based query. For example, profiles 526 can be directly indexed via corresponding coordinates (e.g., longitude, latitude, etc.). Further, indices 525 could representing an indirect set of indices derived from a location coordinate; possibly where a geo-location is converted to a geo-fence identifier and where indices 525 could correspond to geo-fence identifiers. In some embodiments, profile database 520 could operate as a torque profile database where profiles 526 are torque profiles.

In the example shown, each profile has a single index. However, it should be appreciated that a single profile could be indexed via multiple indices where a single profile might be relevant for more than one location. Such use cases are advantageous because it provides for creating a template profile or a default profile that could apply to locations have common features (e.g., desert, nature park, etc.). Further, a single index could link to more than one profile of profiles 526. Such an approach provides for nested or layered operational profiles for a single location. Profile database 520 can be implemented via different ways possibly including an SQL database, look-up table, hash table, file system, or other technique providing indexed data. In some embodiments, the profile database 520 may operate in a remote server over a network. However, it is also possible to place or store profile database 520 in the memory of the vehicular controller (e.g., FIG. 2, controller 320's memory 333, etc.).

Beyond location indices 525, each of the operational profiles can carry additional information as represented by metadata 530 or attributes 535. Queries targeting profile database 520 may also be formed based on the metadata 530 or attributes 535. Thus, the queries can become more complex than merely comprising location data. In response to more complex queries, database 520 generates a result set of profiles 520 that satisfy the query, including providing profiles having metadata 530 or attributes 535 that satisfy the query. Metadata 530 represents data describing the nature of the data related to the profile (e.g., creation time, data size, data formatting, version number, etc.). Attributes 535 provide additional information related to the overall profile and could include a profile owner, relevant vehicle information (e.g., make, model, year, etc.), target weather conditions, or other information.

Profile 526, in more interesting embodiments, include one or more of torque curves 540. Torque curves 540 provide details to the LSV vehicular controller on how to manage the torque of a motor in order to drive one or more wheels of the LSV. Thus, the vehicular controller uses torque curves 540 to determine or otherwise establish commands or instructions submitted to the motors (e.g., setting register values, setting PWM values, etc.). Further, torque curves 540 can also comprise one or more curve criteria 543 by which the LSV vehicular controller determines which curve to use or even which portion of a curve to use. For example, curve criteria could comprise instructions on which of curve 540 to use when raining or what point on the curve to use when starting or stopping the LSV. Yet further, curves 540 can comprise one or more operational envelopes 541 that sets a boundary around a corresponding curve. Envelopes 541 may be used to set boundary conditions that should not be exceeded when applying torque to the motors given a set of conditions. While envelop 541 may be used to set restrictions, the restrictions are not required to be on or off but could be based on a spectrum of conditions. For example, envelope 541 may be exceeded based on current conditions (e.g., emergency, weather, etc.).

One should appreciate that torque profiles could apply to different wheel configurations. In some embodiments, a torque profile may only apply to a single motor driving a rear-wheel drive LSV. In some embodiments, a motor can engage a single axel via a reduction drivetrain or transmission (e.g., 13 to 1, etc.). Further a torque profile could apply to a single motor. Thus, for example, a four-wheel vehicle could comprise four hub motors that each drive a single wheel. Such an approach is advantageous because it permits each motor to operate under different profiles, possibly in cases where one set of wheels are on one type of terrain (e.g., grass) while another set of wheels are on a different type of terrain (e.g., sand). Said differently, the torque profiles may apply to a single motor to account for more than one, two, three, or more terrain types. Therefore, torque profiles may apply to a wheel-by-wheel basis, motor-by-motor basis, axel-by-axel basis, or other practical configurations. Additionally, more than one torque profile may be applicable to a single motor so that two, three, five, 10, or more profiles may be returned from profile database 520.

While torque curve 540 is illustrated as radial speed, in radians per second, versus torque (T), there is no restriction on how the curve can be represented in a digital format. For example, torque curve 540 can further comprise a torque adjustment curve that governs how motors should behave with respect to torque from one point in time to another (e.g., starting, stopping, accelerating, decelerating, etc.). Such adjustment curves are advantageous especially when local conditions change due to shifts in terrain as the LSV moves from area to area, to changing weather conditions, to safety concerns, or other factors. Of note, the adjustment curves can include acceptable torque as a function of time. In such cases, envelope 541 may include restrictions with respect to the rate at which torque is applied or changes. Thus, the torque adjustment curves may include acceptable rates of change in applied torque based on time, or higher derivatives in time (e.g., 2^{nd} order derivatives, 3^{rd} order derivatives, 4^{th} order derivatives, etc.). Such higher order derivatives in time may be used in conjunction with other operational parameters beyond torque as well. One advantage of using higher order derivatives includes smoothing transitions from one state of operation to another state by ensuring the changing operational parameters from state to state have matching or similar values of higher order derivatives at a specific time or during a transition period even as the lower order derivatives change. Interestingly, a path taken mathematically to create a match for higher order derivatives for a specific action (e.g., acceleration, etc.) does not have to be the same, albeit reversed, path taken when performing an opposite action (e.g., deceleration, etc.). Thus, there can be a hysteresis between such paths. Said differently, the ramp down behavior of a set of operational parameters (e.g., speed, etc.) does not have to be the same as the ramp up behavior.

In some embodiments, profile 526 can further include context template 537 representing rules or instructions by which the vehicular controller may adjust the corresponding operational parameters of the LSV. Context template 537 can comprise a set of triggering events that cause specific actions or operational adjustments to take place. One should appreciate that context template 537 might not have actual values for event triggers, but rather one or more sets of criteria by which the events are triggered. More specifically, as the vehicular controller observes the local environment via sensor data, the vehicular controller can use the sensor data to determine which triggers should fire or to determine which set of criteria for triggering the event is most relevant at a current instant in time. Context template 537 can be encoded as a markup file, script, or other machine-readable format. Further, context template 537 can be defined in terms of the operational curves (e.g., torque curve 540), especially with respect to envelope 541 to ensure operational parameters do not exceed defined limits. Additional details regarding local contexts, possibly based on one or more of context template 537 are described with respect to FIG. 7.

Although FIG. 5 focuses on torque, one should appreciate profiles 526 can include other operational profiles beyond torque or in addition to torque. In a similar vein, where torque curves 540 apply to the operational parameter of torque, operational profiles can include other types of operational curves as well as the criteria triggering when such operational curves are employed. Thus, operational profiles can include parameters including one or more of the following in addition or alternatively to torque: tire pressure, battery discharge rate, battery recharge rate, air conditioning use parameters, electrical loading, weight or loading parameters, or other types of operational parameters. As an example, consider tire pressure. In some embodiments, the LSV can be equipped with self-inflating tires. As the LSV traverses various terrains, the vehicular controller can consult an operational profile provisioned with tire pressure parameters and thereby generate one or more instructions to change the pressure of the corresponding tire or wheel. The pressure may be increased to reduce friction to ensure optimal performance on solid surfaces (e.g., pavement, etc.). Additionally, the pressure may be decreased on softer surfaces (e.g., sand, mud, lawn, etc.) to enhance friction for better grip.

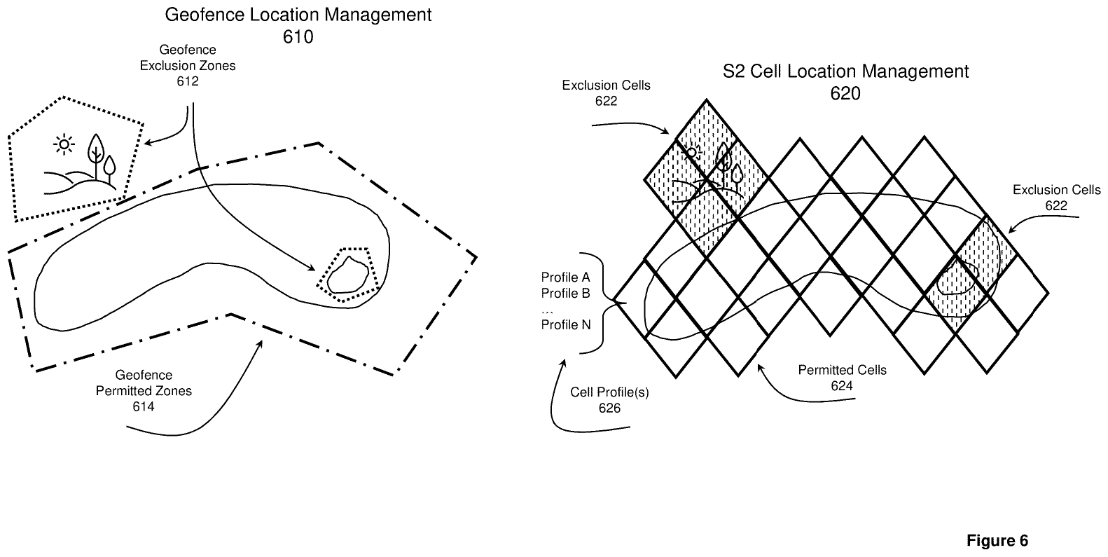

FIG. 6 provides an overview of how operational profiles may be used in relation to a geolocation of an LSV. FIG. 6 provides two example use-cases: geolocation fence management 610 and S2 cell location management 620. Starting with a focus on geolocation fence management 610, consider the area as illustrated, a golfing fairway and green similar to environment shown with respect to FIG. 1. As discussed previously, such environments may have multiple terrain types or other environment zones. In the example shown, there are two main zones: a set of geofence exclusion zones 612 and at least one geofence permitted zone 614. As suggested by their names, exclusion zones 612 are constructed to restrict an LSV from entering such zones; say exclude or restrict an LSV from driving on the green or be restricted from operating in the natural area. While it is possible to simply have a NULL set of operational profiles for such zones when the LSV enters the zone, it is also possible to have a set of operational profiles that explicitly provide command infrastructure for the motors, wheels, or other features of the LSV. For example, operational profiles from exclusion zones 612 might include operational adjustment curves that require the LSV to decelerate to zero speed when entering the zone. Further, the corresponding profiles might only permit the LSV to move in a direction toward a closest boundary of the zone to allow the LSV to leave the area, perhaps slowly (e.g., less than 5 mph, etc.) coupled with rolling without slipping. Interestingly, in such situations, the local context becomes more important to further refine how the LSV behaves. More specifically, instructions for the motors, wheels, or other operating features may be refined to account for the orientation of the LSV to determine which directions are forward or backward, to account for safety or emergency considerations, to account for actions taken by the operator, or to account for other factors. Use of geofences provides for course grained control over operational profiles, but also provides for creating well defined boundaries that are more natural to the environment.

Example techniques for managing geofences include those provided by Google® Geofencing API (see URL developers.google.com/location-context/geofencing). From a practical sense, an LSV's location data (e.g., GPS geolocation, observed location, etc.) may be used to identify a specific geofence zone, possibly having a zone identifier. The zone identifier may be used as a geofence query to one or more profile databases to retrieve a result set of relevant operational profiles. As illustrated in the geofence location management example, such zones may be nested, overlap, or otherwise impact each other. In such cases, operational profiles may be given priority values, possibly as an attribute of the profiles, to allow the vehicular controller to determine which profile should take precedence over others (e.g., higher value is high precedence, lower value is high precedence, etc.).

Turning toward S2 cell location management 620, the same environment could be tessellated with area cells as illustrated. S2 cells represent a method by which an area may be partitioned into cells using a Hilbert curve. An advantage of S2 cells is each cell has a unique, well-defined identifier where neighboring cells have similar identifiers due to the nature of the Hilbert curve. This is advantageous because it permits a computer system to use identifiers or portions of the identifiers to find neighboring cells, which in turn, permits the disclosed systems (e.g., see profile database 420 in FIG. 4), to find profiles for a target cell or group of related cells. Example techniques describing S2 cells and identifiers may be found at URLs s2geometry.io and github.com/google/s2geometry.

The cells may overlap or not overlap as desired by the target implementation. In more preferred embodiments, the cells completely cover the target environment as illustrated. Further, in principle large geographic regions (e.g., city, zip codes, counties, states, countries, continents, the entire planet, etc.) could be covered via such cells. In view that each cell has a unique identifier, corresponding operational profiles may be indexed by the cell identifiers, possibly using a hierarchical tree data structure. Thus, queries having an identifier of a course grained cell can return a result set of profiles for more fine-grained cells related to the identifier. Thus, a single cell might return a single profile, multiple cell profiles 626 as illustrated, no profiles, or even profiles from neighboring cells as well as a target cell.

Similar to geofence location management 610, S2 cell location management 620 can include different types of zones, which could impact the nature of the corresponding operational profiles. For example, some cells may be identified as exclusion cells 622, which restrict operation of the LSV as discussed above. Alternatively, cells may be identified as permitted cells 624 where the LSV operation is not restricted or has less restrictions. FIG. 6 presents two types of zones, permitted zones and excluded zones; however, zones may be defined according to any practical schema. Example zone definitions or categories could include maintenance zones, safety zones, grounds-keeping zones, emergency zones, or other types of zones. In such cases, operational profiles could default to the corresponding zone's default profile definition or default template if no a priori defined profiles exist for the target area. Use of S2 cells are advantageous from the perspective of fast memory look-up based on cell identifiers and the ability to tesselate an area. However, S2 cell may be less advantageous because they do not necessarily provide for fine-grained alignment to natural boundaries. Thus, in some embodiments, a hybrid approach of using geofences to define a zone and then using S2 cells to tessellate a zone may be of high value.

There are additional technologies that may be employed for zone management beyond geofencing and S2 cells without departing from the nature of the inventive subject matter. Examples include use of Google® plus codes, which operate somewhat similarly to S2 cells (see URL maps.google.com/pluscodes). Example map management technologies include Google® maps API or Microsoft® Intelligent Maps API both offers executable services providing access to maps. Further, OpenStreetMap offers access to a user created set of map-related services via an open-source model (e.g., see URL www.openstreetmap.org).

FIG. 7 illustrates a possible approach for use of a local vehicle context 700 to refine actual functionality of an LSV based on an operational profile. Local context 700 can be considered a set of digital local environment data 757 obtained from a set of sensors 750 (e.g., sensors 750A through 750N, etc.) as well as various rules. As the vehicular controller collects sensor data 755 from sensors 750, the vehicular controller builds up, derives, or otherwise compiles the corresponding environmental data 757 for use with local context 700. Local vehicle context 700 can take on a broad spectrum of forms. For example, local vehicle context 700 could comprise a base, but empty, template (e.g., XML, YAML, JSON, etc.) found within the corresponding operational profiles where the template has rules, values, code, scripts, or other programmatic features the vehicular controller may use to create a provisioned local context. In the example shown, local vehicle context 700 comprises a set of sensor triggers 720 by which the vehicular controller may (or might not) take action. Sensor triggers 720 are presented to illustrate that environmental data 757 or sensor data 755 can operate based on many different types of data including text values, integer values, derived values, calculated values, floating point values, or other types of values. Further, sensor data 755 and the resulting environmental data 757, in more preferred embodiments, may be collected in real-time where the vehicular controller can take immediate action based on the observed state of the LSV. As an example of the data flow, sensor data 755 may include a data from a moisture detector, which returns a value of 0 to 255. The corresponding environmental data 757 could simply include the exact same value, possibly as a pass through. However, environmental data 757 could also be the derived value “RAINING” which may be derived by converting the raw value to the derived value via a corresponding conversion function, possibly implemented as a look-up table or as a set of rules.

While the above immediate discussion indicates local context 700 could be a template provided by a corresponding operational profile, one should appreciate that such an implementation is not the only technique for implementing local context 700. In other embodiments, the vehicular controller can have a local context agent (e.g., software, modules, etc.) that executes on the vehicular controller. The local context agent can monitor the local environment conditions and then submit the conditions (e.g., via API, via memory mapped TO, etc.) to an executing profile. The profile itself, also possibly operating as an agent, task, thread, or other set of instructions can then generate appropriate instructions for execution. Thus, local context 700 could be considered as an integral part of an operational profile or could be a distinct set of code from a corresponding operational profile, but yet able to informationally couple with the operational profile. Such communications may also be bi-directional.

As sensor data 755, and the corresponding environmental data 757, flows into the vehicular controller, the vehicular controller monitors sensor triggers 720, which may operate as listeners. When the vehicular controller determines that one or more of sensor triggers 720 have rules that are satisfied by the local environmental data 757, or other data, the vehicular controller can then generate a corresponding set of instructions (e.g., motor instructions, wheel instructions, operating instructions, etc.) according to the corresponding operational profile as by informed local context 700. For example, one or more operating instructions may be registered with the corresponding listeners for sensor triggers 720. Thus, when the listener has its corresponding criteria satisfied, the instruction can be executed, compiled, submitted to the target device, or otherwise prepared for execution.

In the example shown in FIG. 7, a set of operational instructions are presented as a set of operating adjustments 730. Operating adjustments 730, in addition to being executable commands, can be also considered a set of changes to the operating conditions of the LSV. For example, during operation a tire pressure might be increased in units of 10% per unit time as the LSV transitions from one terrain type (or zone) to another until a desired pressure is achieved. It should be appreciated that the operating adjustments can take on a wide range of possible operating instructions, possibly including a stop instruction, a shift load instruction, an accelerate or decelerate instruction (e.g., increase or decrease torque, etc.), an operator notification instruction, a battery charge instruction, or other type of instruction relating to the operational parameters of the LSV. Still further operating adjustments 730 could leverage electromagnetic braking, which may be used to recharge the batteries of the LSV. In the example shown, when the vehicular controller detects a downward slope, the controller may automatically engage electromagnetic braking to control the speed of the vehicle, possibly for safety reasons, and to recharge the batteries. Although the corresponding sensor trigger 720 for electromagnetic braking is illustrated as a single criterion, any practical number of criterion may be combined to form the trigger (e.g., speed, position, orientation, operator, battery level, etc.).

Recall the LSV can have many different types of configurations where motors impact the performance of one, two, or more wheels. Thus, a set of wheels (e.g., one, two, three, four, or more wheels) can operate individually or collectively based on their corresponding motor or motors. In such cases, the instructions generated by the vehicular controller could comprise different instructions for two different wheels at the same time. Additionally, the different instructions may be representative of two (or more) different terrain types. This is considered advantageous in cases similar to where an LSV might be stuck halfway into a ditch or sand and still be halfway on pavement for example. More specifically, the tire pressure for the sand wheels might be decreased for better grip, while torque on the pavement wheels might be increase because those wheels have more established contact with the surface. Thus, the result can include instructions for the motors to turn the wheels in a manner the promotes rolling without slipping.

Once a set of operating instructions have been established, or are instantiated in real time, the vehicular controller executes the set of instructions to thereby enable the corresponding operating features of the LSV to take action. For example, in the specific example of motor torque as an operating parameter, the controller executes the generated set of wheel instructions to enable the motors to cause the set of controllable wheels to take the desire corresponding action.

The above discussion has mainly focused on wheel-based LSVs. However, the described inventive subject matter is also applicable to other types of electric vehicles in view that nearly any kind of vehicle having motor-driven propulsion could leverage the location-based operational profile management features. Example vehicles can include boats, ships, planes, drones, autonomous vehicles, motorcycles, single wheeled vehicles, unmanned vehicles, fan driven balloons, zeppelins, lighter than air crafts, snowmobiles, or other types of devices. Thus, by extension, motors do not necessarily have to be coupled to wheels, but could be coupled to other types of propulsion (e.g., treads, impellers, ducted fans, water or air propellers, robotic legs, etc.). Consider drones as an example. Electric drones are used for many purposes from hobby use-cases to military use-cases. Location-based operational profiles for such drones could include profiles to control maximum rotation speed of the drone's propellers in order to reduce noise (e.g., over a neighbor, over an active battlefield, etc.). Further, such restrictions can be further modified based on the local context, possibly based on ambient noise levels (e.g., raining, battle noise, highway noised, etc.), to alter the restrictions. More specifically, if the local ambient noise is high, then the local context might modify the value of the maximum rotational speed by permitting the drone to lift more, move faster, or otherwise have faster rotational speeds. Thus, in additional to other use-cases, the inventive subject matter is considered to include noise abatement.

In a somewhat similar vein to drones, the disclosed techniques could be used for lawn care devices (e.g., lawn mowers, robots, etc.) including robotic lawn mowers or other types of autonomous devices. Rather than merely have a robot perform a single task in a bounded area, the robot can consult operational profiles for an area and possibly modify the profile based on the local context to proceed with designated tasks. Returning to the environment of FIG. 1, a robot or a fleet of robots could tend to the various terrains in the environment. For example, a single automated lawn mower could use the profiles to determine which type of blades to use for the type of grass or what height the blades should be for the type of grass. As the mower shifts from the fairway to the pavement, the blade deck can be raised to permit faster movement. Thus, operational profiles may be used to fine-tune how automated devices operate in an environment and further refine operational parameters based on the local conditions or contexts. Additionally, the lawn care example also illustrates the operational profiles can be used to manage non-propulsion features (e.g., the lawn mower blade, blade deck, etc.).

Up to this point in the discussion regarding the inventive subject matter, the disclosed techniques have been presented from the perspective of a single LSV. In addition to managing the operational parameters or performance of a single LSV, fleets of LSVs could also be managed via these techniques. Thus, many LSVs, or other types of electric vehicles, can work together in concert to create a globally optimized set of operational tasks. For example, multiple devices (e.g., a set of heterogenous device, a set of homogenous devices, etc.) could be optimized to reduce overall costs of charging, to reduce time to perform global activities (e.g., ground care, etc.), to increase coverage per unit time on surveillance footage, or other factors. In such widely varied multi-device use cases, each device could be governed by a single profile for a target zone and then modify the profiles for local conditions or each device could obtain a profile that it most relevant to its local area. Such approaches permit multiple devices to work together without conflicting with each other by sharing workloads or cooperating with each other. Returning to the lawn mower and golf course example in FIG. 1, multiple, possibly automated lawn mowers, could share mowing the fairway to reduce the amount of time necessary to complete the task. Further, an automated charging station could travel around the environment to automatically swap or charge batteries of the lawn mower so they do not have to spend time traveling to and from a charging station. Yet further, operational profiles could permit or restrict the number of devices in a specific area (e.g., proximity to each other, density of devices, etc.) to reduce potential interference with each other, to reduce wear on the terrain, to improve the logistics, or other factors.

Yet another interesting use case of the operational profiles relates to communications. Recall, in FIG. 3, the disclosed vehicular controller is shown as having a wireless communication interface (i.e., wireless communication 350). In some multi-device embodiments, it is possible that an environment might not permit all devices to access a central server or cloud infrastructure. In such cases, the vehicular controllers can establish a mesh or adhoc network for distributing operational profiles. For example, one or more LSVs that do have access to the profile database can download necessary profiles that are relevant to LSVs that are not connected to the profile database. Then, the profiles can be distributed to the various unconnected LSVs via the mesh or adhoc network via the wireless communications interface. Thus, LSVs can operate as a hub or proxy profile database or server.

In view an operating environment can be quite varied or there can be multiple vehicles operating in the same environment, there can be quite a diversity of operational profiles and/or corresponding local contexts. The diversity and possibly large number of profiles could be quite difficult to manage. Therefore, the inventive subject matter is considered to include infrastructure to support management of operational profiles. In more preferred embodiments, one or more web services (e.g., dashboards, APIs, etc.) are provided by which stakeholders are able to create or otherwise manage profiles. Such management services may be hosted on a local computer system, possibly for a fee, by which an environment manager can manage profiles or acceptable local contexts. In other scenarios, the services could be hosted on cloud-based systems, possibly accessed in exchange for a subscription fee. Preferred services offer multiple management functions including monitoring LSVs, inventorying LSVs and their individual capabilities or features, logging events generated by LSVs especially when the local context gives rise to potential conflicts about LSVs or with operational profiles, alerting stakeholders of specified events, reporting on conditions associated with one or more LSVs, recovering an LSV should adverse events take place, securing LSVs against unauthorized access or use, or engaging in other management functions.

Security can be considered a very interesting feature relating to the disclosed location-based profile management system. Operational profiles can further include security requirements, possibly in real-time, as LSVs move from position to position in an environment or as operators change. Thus, the operational profiles can include restrictions relating to the operator, who may be required to authenticate themselves when operating the LSV. Operational profiles can be provisioned with security features possibly including operator credentials or security protocols for establishing use (e.g., public key infrastructure (PKI), hash-based message authentication code (HMAC), Secure Sockets Layer (SSL), certificates, multi-factor identification, etc.). In some embodiments, an operator could be given a keyfob having a specific radio-frequency identification (RFID) value. The LSV's operational profile can be provisioned with the expected RFID value so that only the specific keyfob will permit access, assuming the LSV is equipped with a RFID reader. Interestingly, RFID readers also permit inventorying equipment loaded in the LSV to ensure it is able to perform a targeted task where the equipment is considered to have RFID tags.

Operational profiles can be provisioned with features that are dictated by external authorities possibly accounting for local laws, government regulations, existing standards of operation, or other factors. For example, templates for operational profiles in national parks can be provisioned with a priori restrictions where LSVs can operate safely or under what conditions the LSV should operate to protect the operator, the vehicle, or the natural terrain. Thus, the operational profiles can be based on various requirements including performance goals, economic goals, task goals, evidence of use goals, adherence to standards, or other factors.

LSVs may also be equipped with one or more displays that enable a local stakeholder or operator to interface with the vehicular controller. Displays can be configured to render one or more aspects of the operational profiles or local contexts so that the operator is able to determine how best to utilize the LSV. Further, providing profile information to the operator enables the operator to understand under what circumstances or restrictions the LSV is operating. For example, as an LSV is approaching an environmental feature (e.g., a change in zone, a change in terrain, etc.), the display can notify the operator of potential changes in behavior of the LSV. Again, returning to FIG. 1 for a more specific example, as an LSV approaches the steep hill as determined from the heading and speed of the LSV, the display can indicate the steep hill has a restricted area or display an acceptable path through to take the hill. Further, the display can present wear-leveling information to the operator, which is especially useful in sensitive zones or in multi-device environments.

Use of the LSV is not restricted to just the behavior of the LSV itself. In addition to the operational parameters of the LSV, operational profiles can be provisioned with implementations of one or more recognition algorithms (e.g., OCR, SIFT, action recognition, pattern recognition, etc.). OpenCV (see URL opencv.org) or SciKit Learn (see URL scikit-learn.org/stable) offer many different types of pattern recognition algorithms, including machine learning algorithms that can be leveraged to identify patterns or items in an environment. Such features are advantageous to identify specific uses of an LSV based on actual operator behavior. For example, should an operator use the LSV in an unacceptable manner, the operational profile can be used to interrupt or stop the observed behavior. In addition, a warning can be rendered on the display of the LSV. Such observations can be based on multiple operating parameters of the LSV including speed, orientation, position, turning radius, location, path, or other sensed parameter of the LSV.

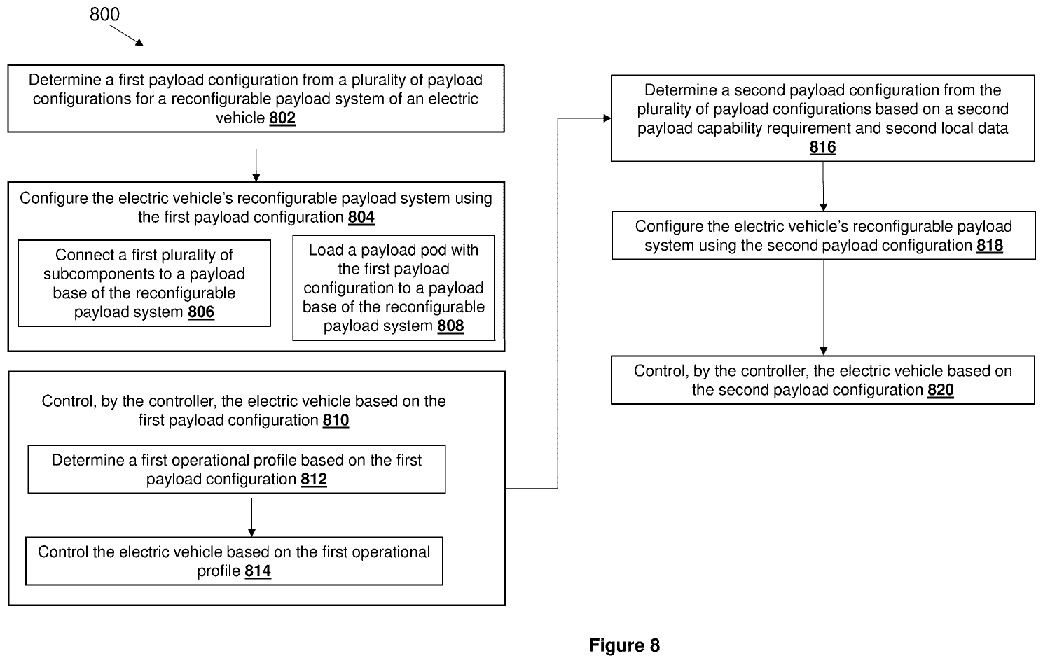

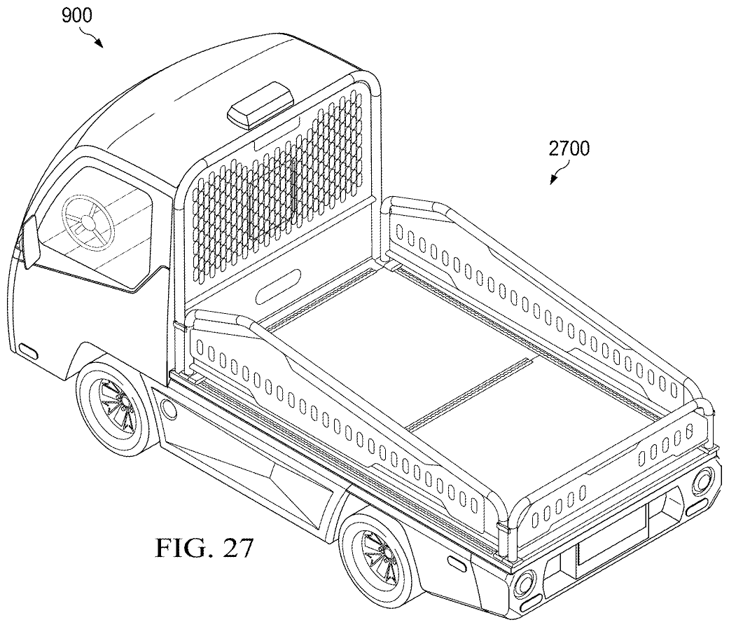

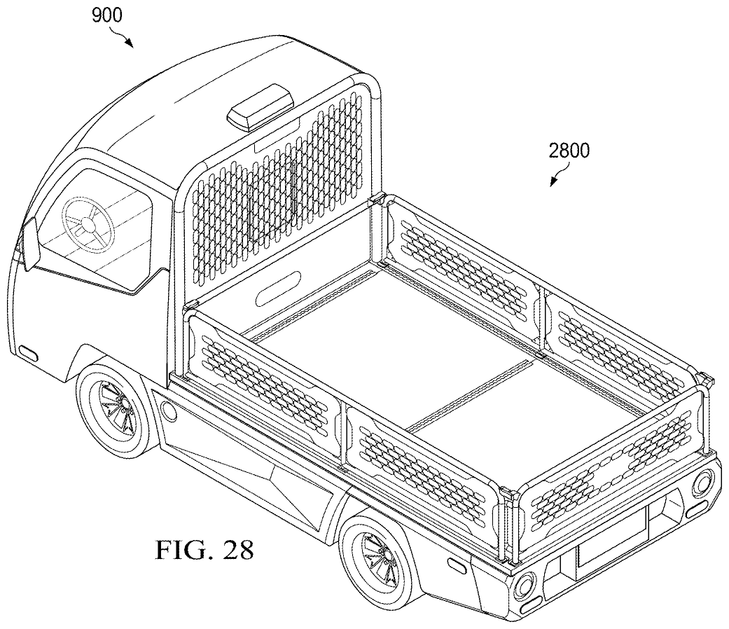

Referring to FIGS. 8-32, examples of systems and methods for providing a reconfigurable payload system (also referred to as payload system) and controlling an electric vehicle with the reconfigurable payload system are described. The reconfigurable payload system may be reconfigured in numerous configurations. In some embodiments, the reconfigurable payload system of different configurations may be constructed using identical constituent subcomponents. The various combinations of subcomponents provide corresponding configurations of the reconfigurable payload system, and create different payload capabilities for an electric vehicle.

Referring to FIG. 8, an example method 800 for providing and controlling an electric vehicle with a reconfigurable payload system is illustrated. The method 800 begins at block 802, where a first payload configuration of a plurality of payload configurations for the reconfigurable payload system of an electric vehicle is determined. In various embodiments, the first payload configuration may be determined based different payload capability requirements and various associated factors, including e.g., different uses, local data, environmental factors, and/or a combination thereof. For example, the same electric vehicle may have the reconfigurable payload system reconfigured for different uses, e.g., resort use during the day, and utility use at night, tailed food deliveries that differ between breakfast, lunch and dinner hours, etc. The payload configurations may include, for example, a flatbed configuration, a pickup configuration, a van box configuration, purpose-built pod configurations, or any other suitable configurations. As such, to allow for different uses of the same electric vehicle, the electric vehicle's reconfigurable payload system may be configured and switched from one payload configuration to another payload configuration.

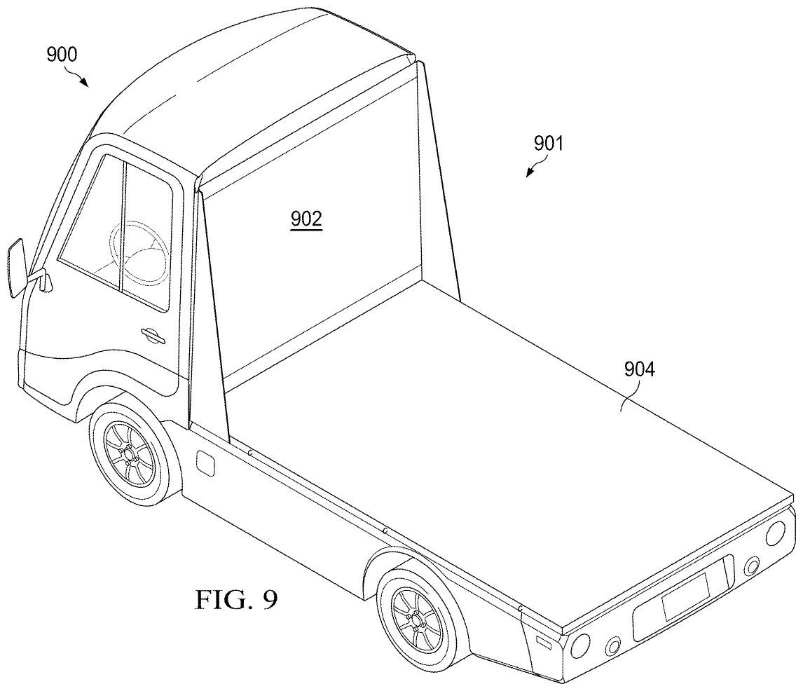

Referring to FIGS. 9, 10, and 11, example reconfigurable payload system 900 having different payload configurations 901, 1000, and 1100 are illustrated. Each payload configuration may have its corresponding specifications, including e.g., capacity volume, payload weight, and curb weight. A payload configuration may be determined, e.g., by matching its specifications to the payload capability requirement. Referring to FIG. 9, example electric vehicle with a reconfigurable payload system 900 having a payload configuration 901 is illustrated. Example payload configuration 901 is a flatbed configuration, and is also referred to as a flatbed configuration 901. Flatbed configuration 901 may be used to easily transport bulky furniture or oversized cargo, e.g., appliances, equipment, or machinery. An example flatbed configuration 901 may have a capacity of 143 cu ft, a payload of 850 lbs, and a curb weight of 2,000 lbs.

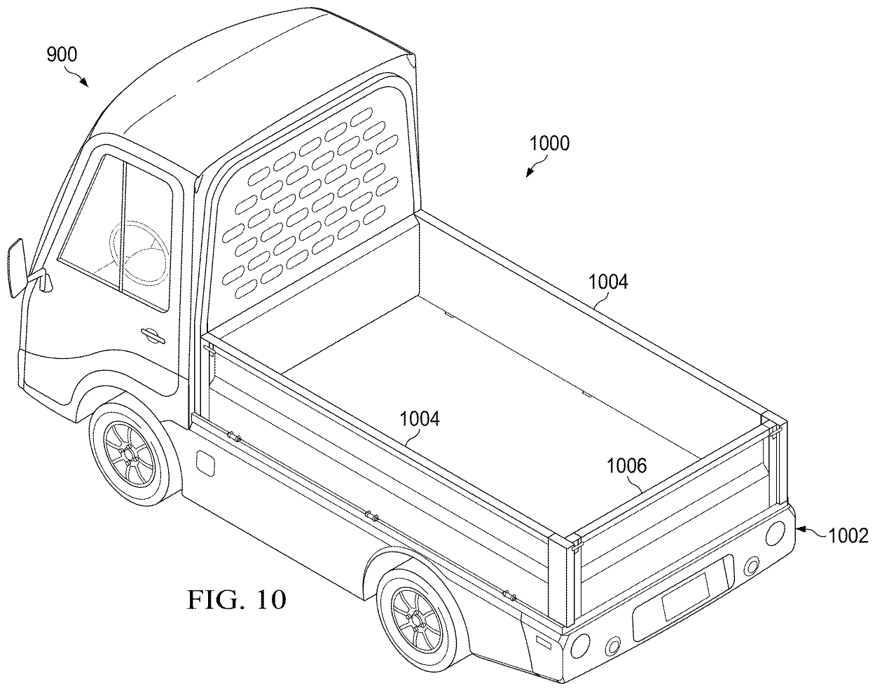

Referring to FIG. 10, an example electric vehicle having a reconfigurable payload system 900 with example payload configuration 1000 is illustrated. Payload configuration 1000 which is an example pickup configuration and is therefore also referred to as pickup configuration 1000. The pickup configuration includes fold-down/hinged side panels 1004 and tailgate 1006, and may be used for maintenance services, construction support, and general cargo hauling. An example pickup configuration 1000 may have a capacity of 139 cu ft, a payload of 795 lbs, and a curb weight of 2,500 lbs.

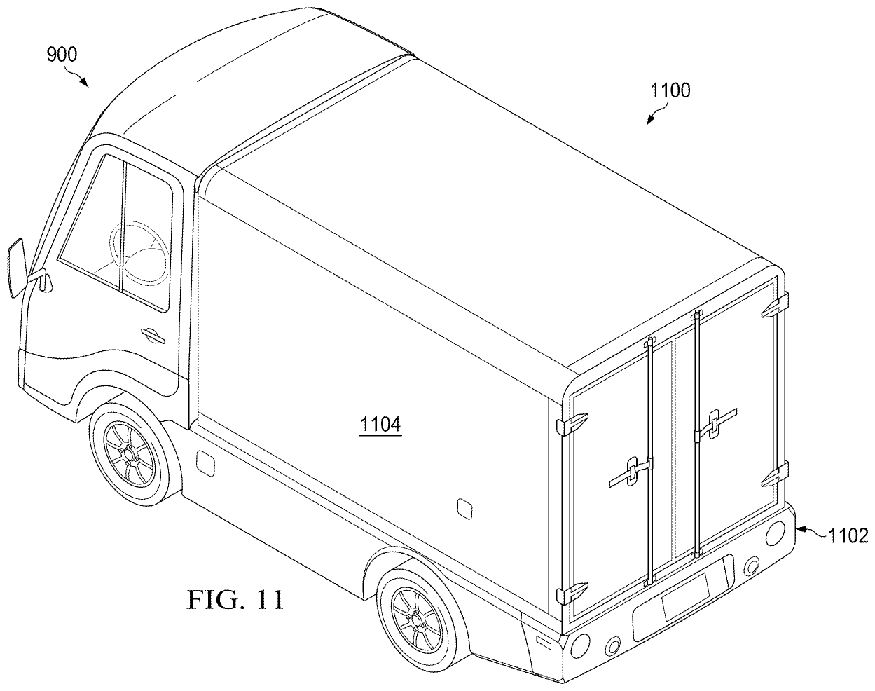

Referring to FIG. 11, an example electric vehicle having a reconfigurable payload system 900 with example payload configuration 1100 is illustrated. Payload configuration 1100 is an example van box configuration, and is therefore also referred to as van box configuration 1100. The van box configuration 1100 provides secure, weatherproof cargo protection, with easy access to the cargo (e.g., from curbside and/or rear doors). An example van box configuration 1100 may have a capacity of 139 cu ft, a payload of 685 lbs, and a curb weight of 3,000 lbs. Note that payload configurations 901, 1000, and 1100 are exemplary only, and additional exemplary payload configurations are described in detail below.

At block 802, a first payload configuration is determined from a plurality of payload configurations (e.g., determined by an operator or determined automatically by a controller) based on a particular payload capability requirement. In some embodiments, a controller may determine a payload configuration by matching its specifications (e.g., capacity volume, payload weight, weatherproof protection, temperature control, security) with the payload capability requirement (e.g., cargo transportation, food delivery, mobile medical/vaccination station, etc.). In some embodiments, a payload configuration may be determined based on the local environment data (e.g., collected by sensors and received by the controller), e.g., for sustainability considerations. In an example, a payload configuration with a lower curb weight may fit in a sustainability environment where low weight is required to reduce impact on local terrain (e.g., golf course, beach, etc.). In another example, a payload configuration with medium curb weight may be considered sustainable and fit in a campus or apartment complex environment where terrain is more forgiving from a sustainability perspective rather than a natural environment (e.g., forest, park, golf course, etc.). In yet another example, a payload configuration with heavier curb weight may not be considered to be sustainable on it would likely not be sustainable to use such a heavy configuration on a natural environment (e.g., forest, park, golf course, etc.), but is considered to be sustainable and fit on more robust terrains such as pavement or rock.

The method 800 may proceed to block 804, where the reconfigurable payload system of the electric vehicle is configured such that the reconfigurable payload system has the determined payload configuration. As shown in blocks 806 and 808, various processes may be used at block 804 to configure the electric vehicle's reconfigurable payload system with the payload configuration.

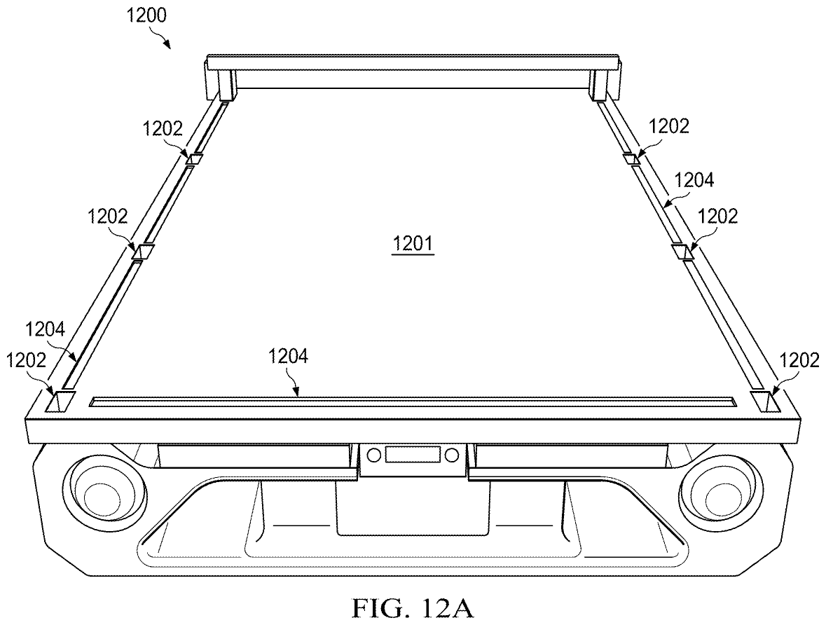

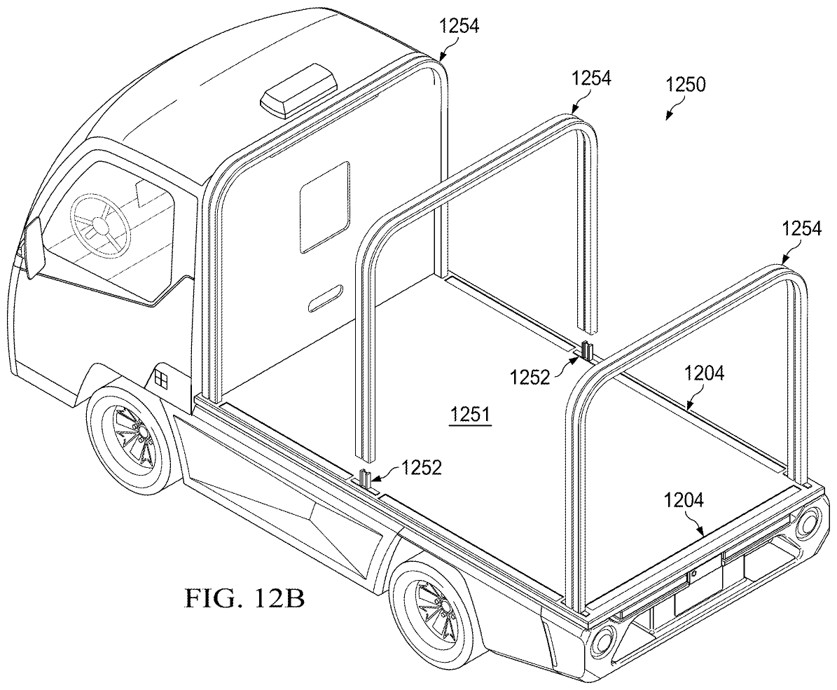

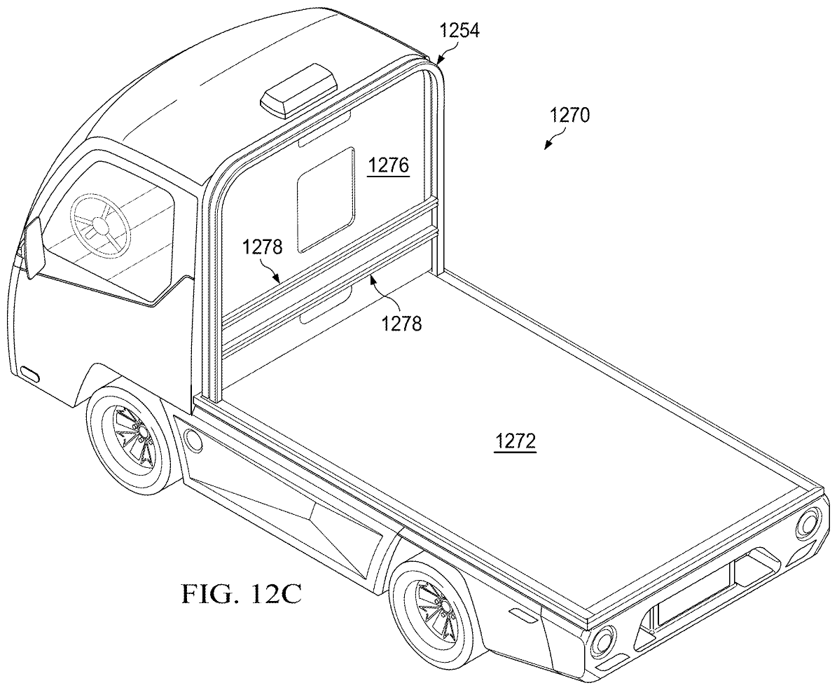

In some embodiments, block 804 may use process 806 to configure the reconfigurable payload system, where the reconfigurable payload system is configured by connecting a first plurality of subcomponents to a payload base of the reconfigurable payload system. Referring to FIGS. 12A, 12B, and 12C, reconfigurable payload systems with various example payload bases for connecting subcomponents are illustrated respectively.

As shown in the example of FIG. 12A, an electric vehicle includes a reconfigurable payload system 1200 with a payload base 1201. The payload base 1201 includes various payload base components, including for example, base connectors (also referred to as bed connectors) 1202 and connector access tracks 1204. In the example of FIG. 12A, base connector 1202 use connector recesses, and are also referred to as connector recesses 1202. Connector access tracks 1204 may include vertical tracks along the sides of the payload base, horizontal tracks along the back of the payload base, any tracks in suitable directions, and/or a combination thereof. The tracked payload base and connector access tracks enable anchoring and securing various subcomponents for the reconfigurable payload system, and may be used to create cargo beds, boxes, tools, access, storage, and working platforms using the reconfigurable payload system. Subcomponents may be anchored and secured to the tracks of the payload base using various well-known vehicle tie down systems, including for example, clamp and trac fixtures, hooks, etc.

In various embodiments, the payload base 1201 may be used to mount payload structure and/or payload subcomponents, and the payload base 1201 may include one or more base plates including slide-on or roll-on pallet structures with roller bases, slide bases, and structure locking pins. In some examples, the payload base 1201 may include a plurality of rollers or bearings that may enable pallets, containers, or other structures to roll on or slide onto the payload base. The rollers or bearings could be directional to allow the payload to be slid or rolled in a longitudinal direction or in a lateral direction. In some implementations, the rollers or bearings are not directional, and the payload may be slid or rolled from any direction. In some embodiments, the electric vehicle may include a lift (e.g., a tilt riser) to raise and lower the base plate of the payload base 1201 to be a roll-on, roll-off cargo configuration. For example, the riser may operate laterally to permit cargo roll-on, roll-off longitudinally or laterally from either side.

As shown in the example of FIG. 12B, an electric vehicle includes a reconfigurable payload system 1250 with payload base 1251. The payload base 1251 includes various payload base components, including for example, base connectors 1252 and connector access tracks 1204. In the example of FIG. 12B, base connectors 1252 use connector studs, and are also referred to as connector studs 1252. One or more horizontal bed arches 1254 are connected to the payload base 1251, using tubes at the bottom to connect to the connector studs 1252. The horizontal bed arches secured to the payload base 1251 may also be used to connect and secure subcomponents to the reconfigurable payload system.

As shown in the example of FIG. 12C, an electric vehicle includes a reconfigurable payload system 1270 with a payload base 1272. A horizontal bed arch 1254 is mounted at the front of the payload base 1272. Further, a cab panel 1276 is secured to the front of the payload base 1272, where tracked horizontal crosswise mounting bars 1278 are installed on cab panel 1276 and/or horizontal bed arch 1254. One or more connection components (e.g., horizontal bed arch 1254, cab panel 1276, tracked horizontal crosswise mounting bars 1278) may be used, together with payload base components, to connect subcomponents to the payload base.

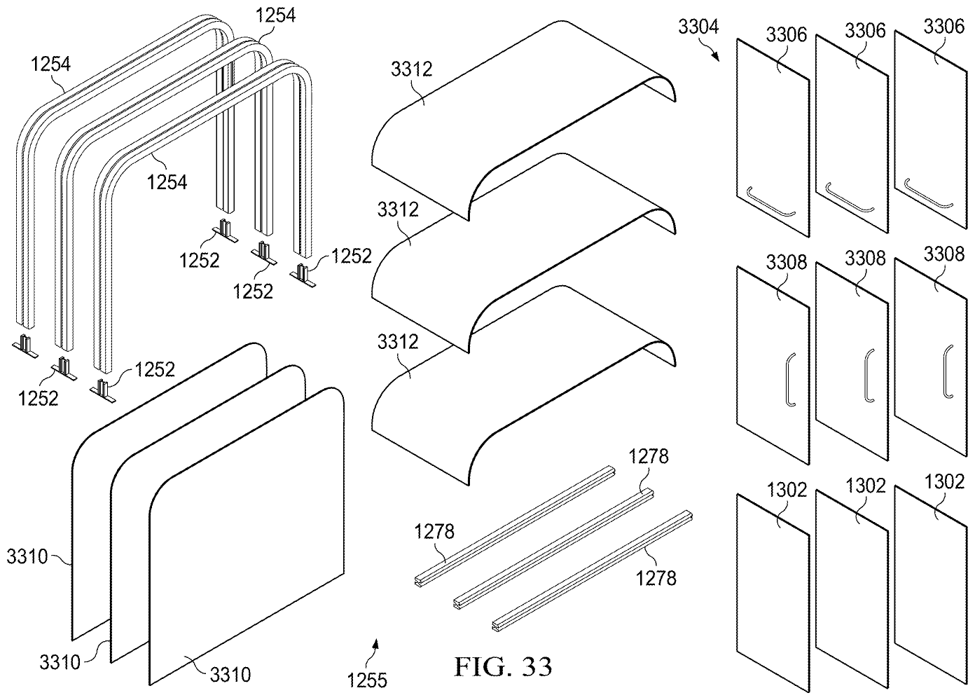

FIG. 33 shows a reconfigurable payload system for a bed of an LSV. The payload system includes a plurality of distinct, modular components or subcomponents usable to configure or reconfigure a particular payload structure for a particular need. As described herein, such a reconfigurable payload system may enable the LSV to be tailored for a variety of different purposes for which the LSV may be desired.

FIG. 33 shows an example implementation of components that may be used to make up the reconfigurable payload structure. The components may include a plurality of bed arches and a plurality of modular subcomponents 1255 that are configured to selectively couple to a bed arch 1254 of the plurality of bed arches. In the example shown, the modular subcomponents include modular cross-mount bars 1278 and modular wall structures 1279.

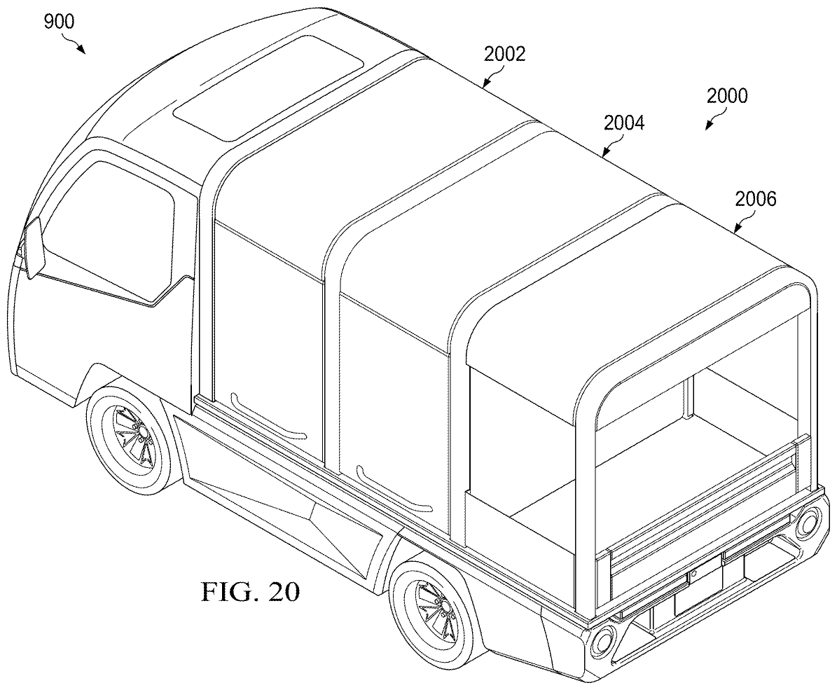

Each bed arch 1254 of the plurality of bed arches may be formed of a sturdy, rigid support from which the modular subcomponents can be suspended or to which the modular subcomponents can be secured. In the example shown, each bed arch 1254 is formed as an inverted U-shape that spans the width of the payload base 1201 (FIG. 12A) of the LSV and connects to the payload at opposing sides. FIG. 12B shows the bed arches 1254 disposed on the LSV at a plurality of spaced locations along the payload base 1201. For example, a first bed arch 1254 is disposed directly behind the cab, a second bed arch 1254 is disposed at the rear of the payload base 1201 and a middle or central bed arch 1254 is centrally disposed. FIG. 12B shows three bed arches 1254, but other implementations use a different number of bed arches 1254. For example, FIG. 20 utilizes four bed arches 1254. The bed arch 1254 may attach to the LSV at the base connectors 1202 (FIG. 12A). In the implementation in FIG. 33, each bed arch 1254 includes a base connector 1252 that extends from the bed arch 1254 to couple to the payload base 1201 by coupling with connectors on the payload base 1201, which in the example in FIG. 12A is shown as bed connectors 1202. In other implementations, the legs forming the vertical stands of the bed arch 1254 may interface directly with the bed connectors 1202 without the need for the base connectors 1252. Although the width of the bed arches 1254 may have a dimensional width in one direction that spans the payload base 1201, the bed arches 1254 in the transverse direction may be about 12 inches or less, such as in a range of about 1-12 inches, and in some implementations, may be about six inches or less, such as in a range of about 1-6 inches.

With the bed arches 1254 in place and extending above the payload base, the reconfigurable payload structure can be created using the modular subcomponents 1255. As noted earlier, the modular subcomponents include modular cross-mount bars 1278 and modular wall structures 1255.

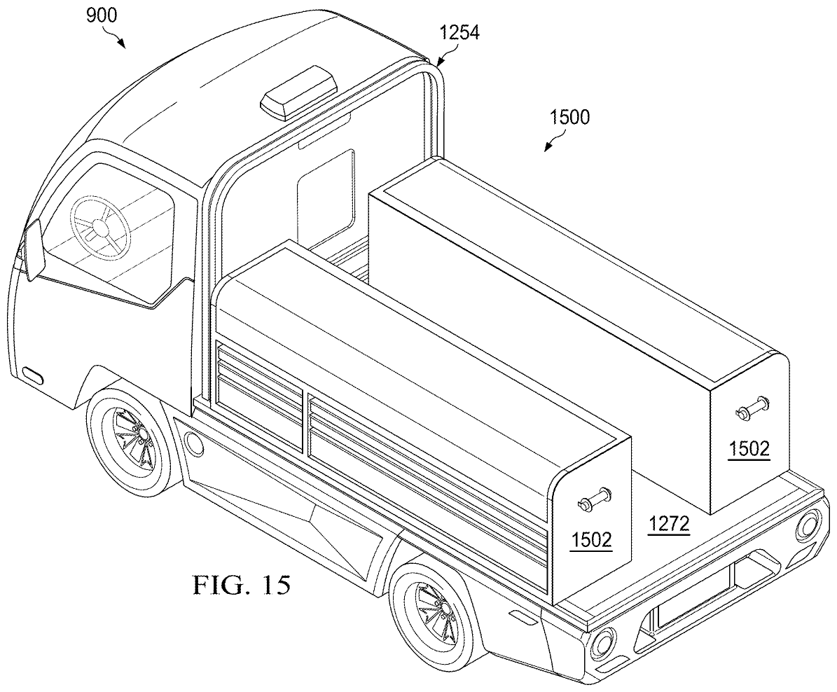

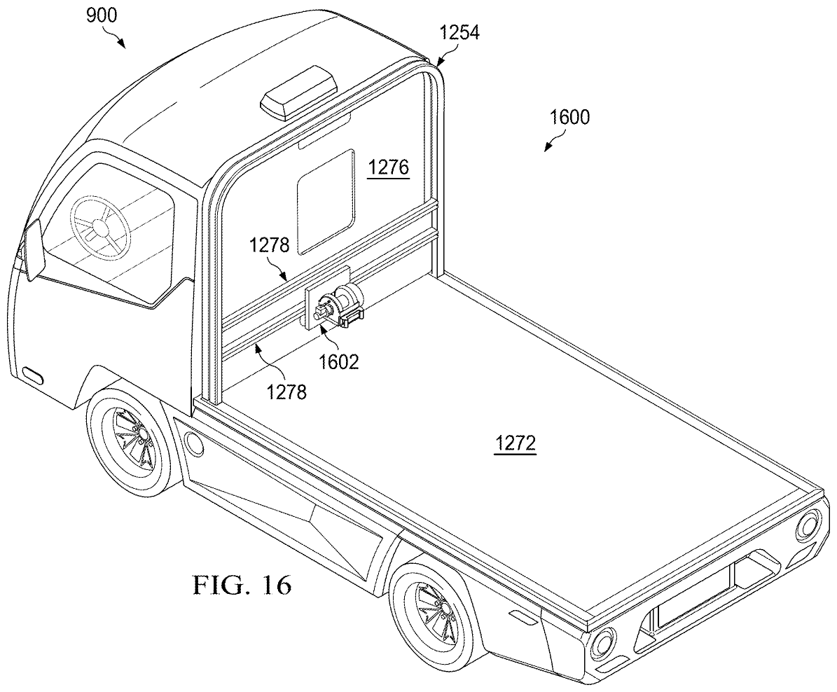

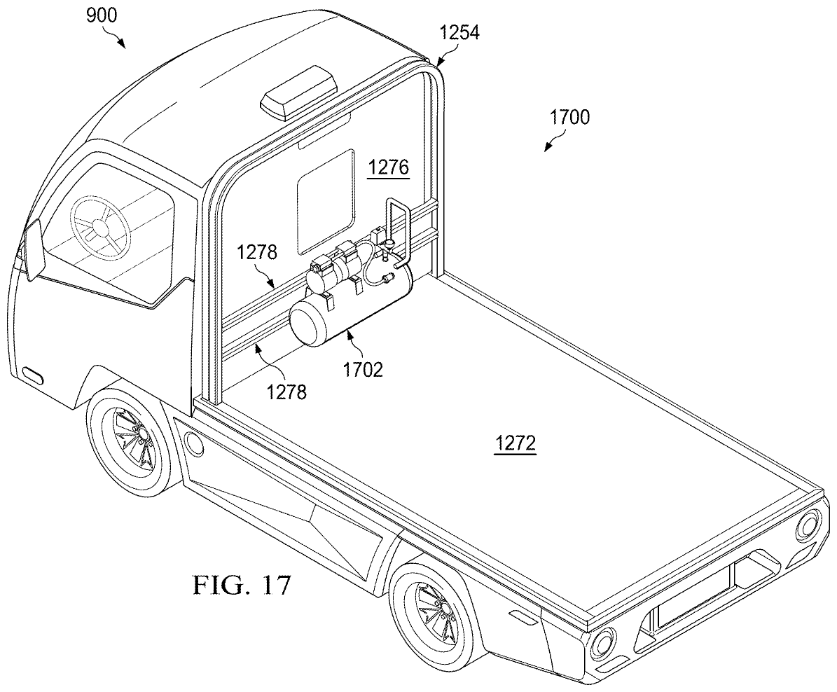

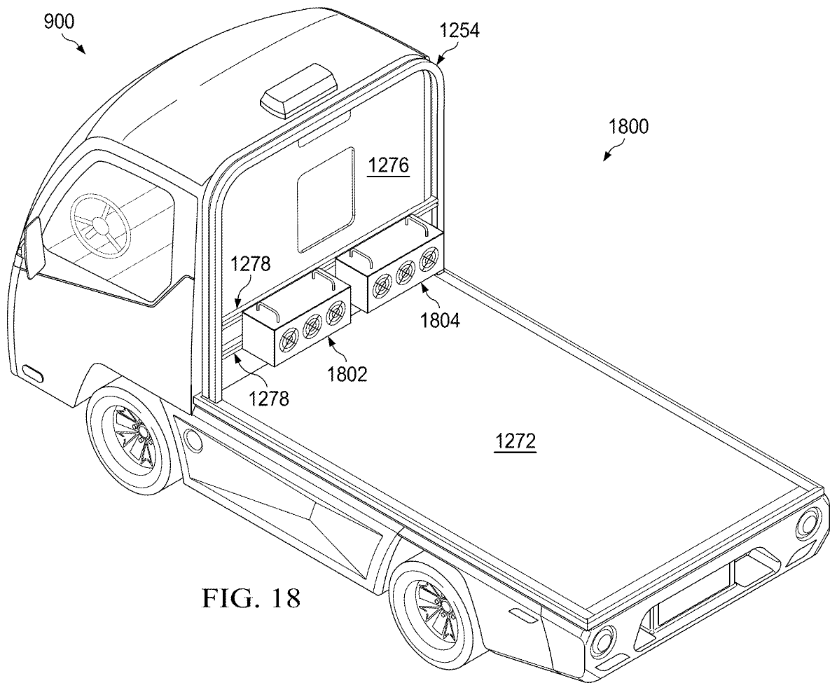

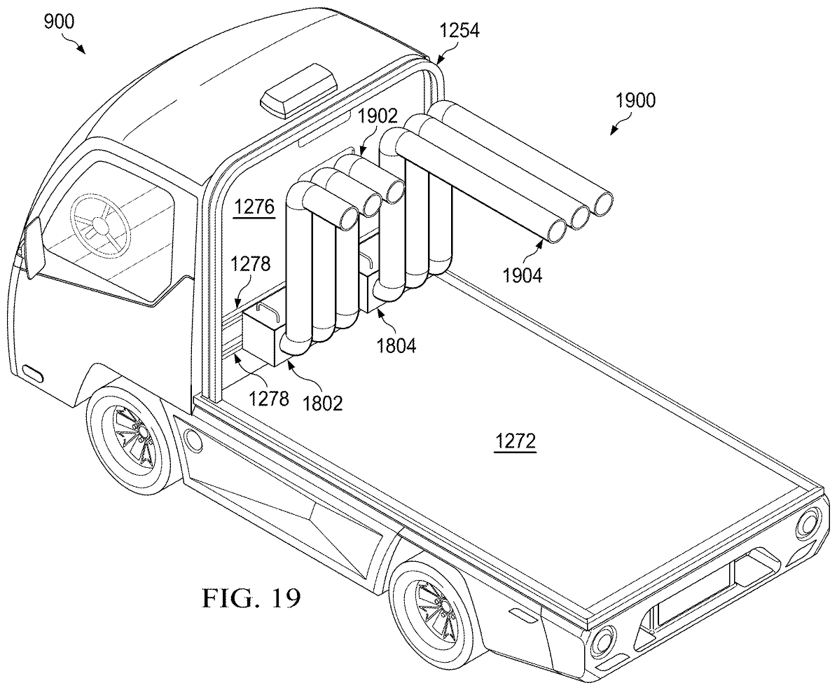

The modular cross-mount bars 1278 are configured to extend from one leg of the bed arch 1254 to the other leg of the bed arch 1254, in the manner shown in FIG. 12C. The modular cross-mount bars 1278 may be secured onto the bed arch 1254 using fasteners that enable the modular cross-mount bars 1278 to be attached or detached to the bed arch 1254 depending upon the desired configuration. The modular cross-mount bars 1278 may be rigid metal bars that may be used to support additional components that permit additional customization of the reconfigurable payload system. For example, the modular cross-mount bars 1278 may support a winch 1602 as shown in FIG. 16, a compressor 1702 as shown in FIG. 17, one or more heat pumps 1802 as shown in FIGS. 18 and 19 or other systems or components. In some implementations, the cab arch 1254 used adjacent the cab may have built-in cross-mount bars. Although the modular cross-mount bars 1278 may have a dimensional width in one direction that spans the payload base 1201 and extends from one leg of the bed connector 1254 to the other leg of the bed connector as shown in FIG. 12C, in the transverse direction the width of thickness of the modular cross-mount bars 1278 may be about 12 inches or less, such as in a range of about 1-12 inches, and in some implementations, may be about six inches or less, such as in a range of about 1-6 inches.

Referring to FIG. 33, the modular wall structures 1255 may be configured to attach to the bed arches 1254 and include a variety of components that attach to or are supported by the bed arches 1254 to at least partially enclose or cover the payload base 1201. In the example shown, the modular wall structures 1255 include a plurality of rigid wall panels 3302, a plurality of rigid doors 3304, a plurality of rigid front-end caps or rigid rear end caps 3310, and a plurality of rigid bed covers 3312.

The rigid wall panels 3302 are shaped and sized to span between adjacent bed arches 1254 to at least partially enclose the payload base 1201. In some implementations, the rigid wall panels 3302 attach to both bed arches 1254. The rigid wall panels may extend from a location just below the curve in the bed arch, along and in the same plane as legs of adjacent bed arches. Thus, the rigid wall panels 3302 may form a sidewall of payload system.

The rigid doors 3304 in FIG. 33 include both vertical doors 3306 and lateral doors 3308. The rigid doors 3304 attach to adjacent legs of adjacent bed arches 1254. In some examples, the rigid doors may pivot about a built-in hinge to move between a closed configuration where the rigid doors are in a closed condition in a plane between adjacent legs of the bed arches 1254 and an open condition in a plane outside the plane between adjacent legs of the bed arches 1254. The vertical doors 3306 may pivot upwardly, and therefore they each include a handle along a bottom region. The horizontal doors 3308 may pivot laterally and therefore they each include a handle along a side region. FIG. 20 shows a payload system with two vertical doors 3306, each disposed between adjacent legs of the bed arches 1254. Although the rigid doors 3304 may have a dimensional width in one direction that spans the distance between legs of adjacent bed connector 1254, in the transverse direction the width of thickness of the rigid doors 3304 may be about 12 inches or less, such as in a range of about 1-12 inches, and in some implementations, may be about six inches or less, such as in a range of about 1-6 inches.

The rigid front-end caps or rigid rear end caps 3310 are usable to separate the payload base 1201 into compartments. Accordingly, in the example shown, the rigid front-end caps or rigid rear end caps 3310 are similar in structure and may extend between legs of a bed arch 1254. The front and rear end caps 3310 may be similar in structure and each are generically referred to as end caps herein. In some examples, the end caps 3310 may connect to the two legs of a bed arch and may also connect to the bar of the leg arch spanning and connecting the legs. FIG. 12B shows an example payload configuration using an end cap 3310 at the bed arch adjacent the cab. FIG. 20 shows an example payload configuration using another end cap 3310 disposed in an intermediate bed arch. Although the end caps 3310 may have a dimensional width in one direction that spans the distance between legs of adjacent bed connector 1254, in the transverse direction the thickness of end caps 3310 may be about 12 inches or less, such as in a range of about 1-12 inches, and in some implementations, may be about six inches or less, such as in a range of about 1-6 inches.

The bed covers 3312 are configured to attach to the upper regions of the bed arches 1254 and cover the payload base 1201 by forming a ceiling or roof structure. As with the other modular components, the bed covers 3312 are configured to be attached and removed from the bed arches 1254 to enable a user to customize the payload structure to a desired need. FIG. 20 shows example bed covers 3312 spanning the distance between adjacent bed arches 1254. Although the bed covers 3312 may have a dimensional width in one direction that spans the distance between to tops of adjacent bed connectors 1254, in the transverse direction the thickness of bed covers 3312 may be about 12 inches or less, such as in a range of about 1-12 inches, and in some implementations, may be about six inches or less, such as in a range of about 1-6 inches.

The modular wall structures 1255 may be configured to attach to the bed arches 1254 to at least partially enclose or cover the payload base 1201 in any type of desired payload configuration. This enables a user to use a first payload configuration for a first task, and to modify or change the payload configuration for a second task. Because each of the modular wall structures 1255 may be removed and replaced with other components, the user has a large number of potential configurations available for us. Accordingly, a user may have a single LSV and have a plurality of bed arches and modular wall structures 1255 that can be used to at least partially enclose the payload base 1201. In the examples described, the modular wall structures all have at least one dimension that is the same so that they can be interchanged for each other. Furthermore, each is configured for easy but secure attachment and removal using fasteners. For example, clips, snaps, and other fasteners may be used to secure the various modular pieces to the bed arches 1254.

In addition to being able to easily reconfigure the payload structure, an advantage to the modular components is that each has a thickness of about 12 inches or less in at least one dimension. Because of this, the components can be packaged and shipped with a minimal amount of wasted space. The size and modular nature enables the components to be stacked and stored side by side with minimal empty space therebetween. When placed in shipping containers, the modular nature also conserves cost, reducing the amount of space needed for shipping.

In various embodiments, at process 806 in FIG. 8, a plurality of subcomponents corresponding to the determined payload configuration are connected to the payload base, such that the reconfigurable payload system is reconfigured with the determined payload configuration. The subcomponents may include various modular structures, including for example, modular wall structures, modular tail gate structures, modular mounting bars, modular bed arches, etc. In various embodiments, the payload configuration may include at least two modular wall structures attachable in a variety of configurations to the plurality of base connectors to form a payload structure at least partially enclosing the base of the electric vehicle. In some embodiments, the at least two modular wall structures comprising at least two of: a rigid wall panel selectively connectable with at least one base connector of the plurality of base connectors; or a rigid door selectively connectable with at least one base connector of the plurality of base connectors; or a rigid front cap or a rear cap selectively connectable with at least one base connector of the plurality of base connectors; or a rigid base cover selectively connectable with at least one base connector of the plurality of base connectors. In some embodiments, each base connector of the plurality of base connectors, the wall panel, the door, the front cap or the rear cap, and the at least one base cover each have a thickness of less than about 12-inches in at least one direction. In some embodiments, the base connectors are a part of base arch connectors sized to span the base of the electric vehicle and provide a structure for the reconfigurable payload system. In some embodiments, the wall panel and the door each comprises common fastening components configured to interchangeably connect to a base connector of the plurality of base connectors.

Referring back to the example of FIG. 9, a back panel 902 is connected to payload base 904 to generate the reconfigurable payload system with a flatbed configuration 901. Referring back to the example of FIG. 10, side panels 1004 and 1004 and tailgate 1006 are connected to the payload base 1002 to create a pickup configuration 1000. Additional examples of reconfigurable payload systems reconfigured with various payload configurations are described with reference to FIGS. 14-31 in detail below.

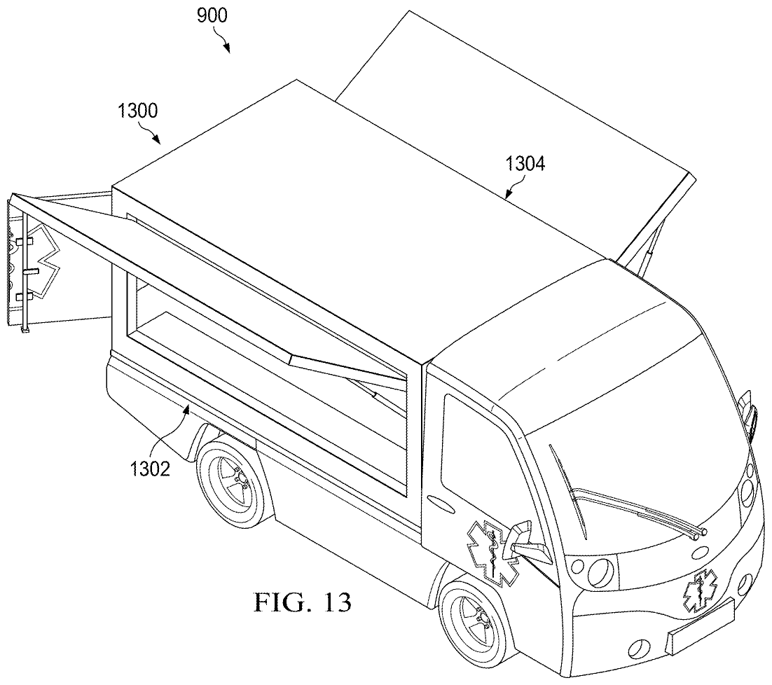

In some embodiments, block 804 may use process 808 to configure the reconfigurable payload system, by loading a payload pod to a payload base of the reconfigurable payload system, where the payload pod is preconfigured with the determined payload configuration. In some embodiments, the preconfigured payload pad includes a pre-loaded pallet subsystem, loaded with a plurality of bolt-on cargos, including e.g., seats, lavatories, galleys, sleep compartments, beverage systems, or tool stations/workstations. The one or more bolt-on cargos may be pre-configured and loaded independent of one another as situational needs dictate. Referring back to the example of FIG. 11, a reconfigurable payload system 900 with van box configuration 1100 is provided, by loading a payload pod 1104 having the van box configuration 1100 to the payload base 1102. Referring to the example of FIG. 13, a reconfigurable payload system 900 with a mobile medical station configuration 1300 is illustrated. The reconfigurable payload system 900 is configured by loading a payload pod 1304 to the payload base 1302, where the payload pod 1304 is preconfigured with the mobile medical station configuration, where the payload pod 1304 includes various pre-configured bolt-on cargoes for the mobile medical station needs.

The method 800 may proceed to block 810, where the electric vehicle may be controlled, by a controller, based on the payload configuration. In some embodiments, at block 812, where the controller determines an operational profile based on the payload configuration of the reconfigurable payload system. At block 814, the controller controls the electric vehicle based on the determined operational profile.

The method 800 may proceed to block 816, where in response to changes of the payload capability requirement and/or the local data of the electric vehicle, another payload configuration is determined from the plurality of payload configurations based on the changed payload capability requirement and/or the local data.

The method 800 may proceed to block 818, where the electric vehicle's reconfigurable payload system is configured, such that the reconfigurable payload system has the updated payload configuration. The method 800 may proceed to block 820, where the electric vehicle is controlled by the controller based on the updated payload configuration.

Referring to FIGS. 14-31, various example payload configurations for the reconfigurable payload system are illustrated. A reconfigurable payload system 900 may be reconfigured with various payload configurations, e.g., by replacing subcomponents connected to the payload base or reloading a pre-configured payload pod to the payload base. A particular payload configuration may be determined from a plurality of payload configurations based on payload capability requirement and/or the local data of the electric vehicle.

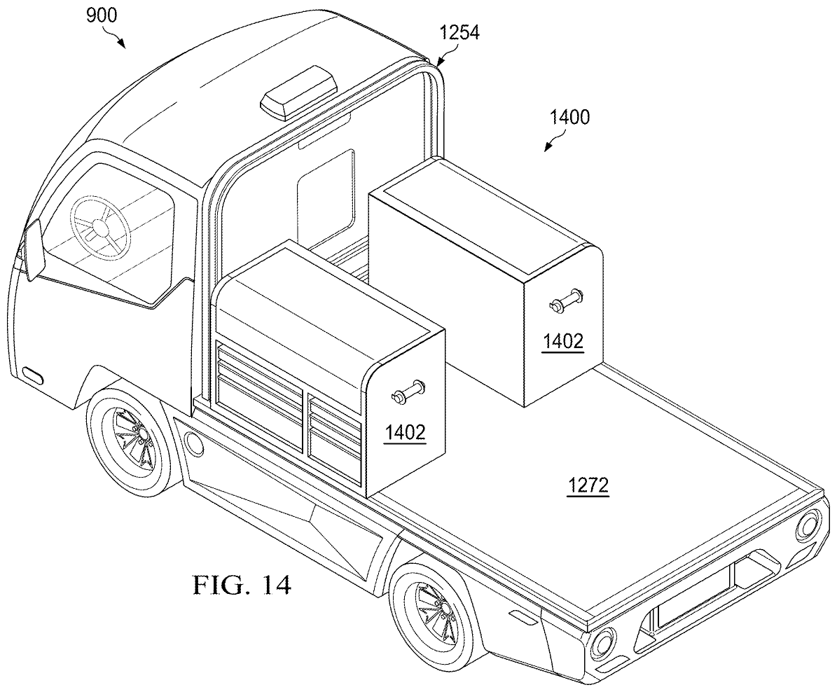

Referring to FIGS. 14 and 15, example payload configurations including toolboxes of various configurations are illustrated. In the example of FIG. 14, reconfigurable payload system 900 is configured to have payload configuration 1400, where medium size toolboxes 1402 are secured to payload base 1272 (e.g., using the horizontal bed arch 1254). In the example of FIG. 15, reconfigurable payload system 900 is configured to have payload configuration 1500, where large size toolboxes 1502 are secured to payload base 1272 (e.g., using the horizontal bed arch 1254).

Referring to FIGS. 16 and 17, example payload configurations using horizontal crosswise mounting bars to secure items of the reconfigurable payload system are illustrated. In the example of FIG. 16, reconfigurable payload system 900 is configured to have payload configuration 1600, where a winch 1602 is secured and connected to payload base 1272 (e.g., using the horizontal crosswise mounting bar 1278 and horizontal bed arch 1254). In the example of FIG. 17, reconfigurable payload system 900 is configured to have payload configuration 1700, where compressor 1702 is secured and connected to payload base 1272 (e.g., using the horizontal crosswise mounting bar 1278 and horizontal bed arch 1254).

Referring to FIGS. 18, 19, and 20, example payload configurations with temperature control for one or more compartments of the reconfigurable payload system are illustrated. In the example of FIG. 18, reconfigurable payload system 900 is configured to have payload configuration 1800, where one or more heat pumps 1802 is secured and connected to payload base 1272 (e.g., using the horizontal crosswise mounting bar 1278 and bar horizontal bed arch 1254). In the example of FIG. 19, reconfigurable payload system 900 is configured to have payload configuration 1900, where plenums 1902 and 1904 with various configurations are connected to each of the heat pumps 1802 and 1804 respectively. In the example of FIG. 19, shorter plenums 1902 are connected to one heat pump 1802 for one compartment (e.g., with a cooler temperature requirement) of the reconfigurable payload system, and longer plenums 1904 are connected to another heat pump 1804 for another compartment (e.g., with a warmer temperature requirement) of the reconfigurable payload system, such that temperatures of different compartments of the reconfigurable payload system may be controlled separately and independently. In the example of FIG. 20, reconfigurable payload system 900 is configured to have payload configuration 2000, adding roof panels, door panels, and insulated dividers to the payload configuration 1900 such that the reconfigurable payload system 900 is configured to have closed compartments 2002 and 2004, and an open compartment 2006. The compartment 2002 may use the heat pump 1802 with the shorter plenums 1902 for temperature control. The compartment 2004 may use the heat pump 1804 with the longer plenums 1904 for temperature control. In various embodiments, payload configuration 2000 may be used for various services that need temperature controls, e.g., food delivery, pharmaceutical delivery, beverage delivery, etc.

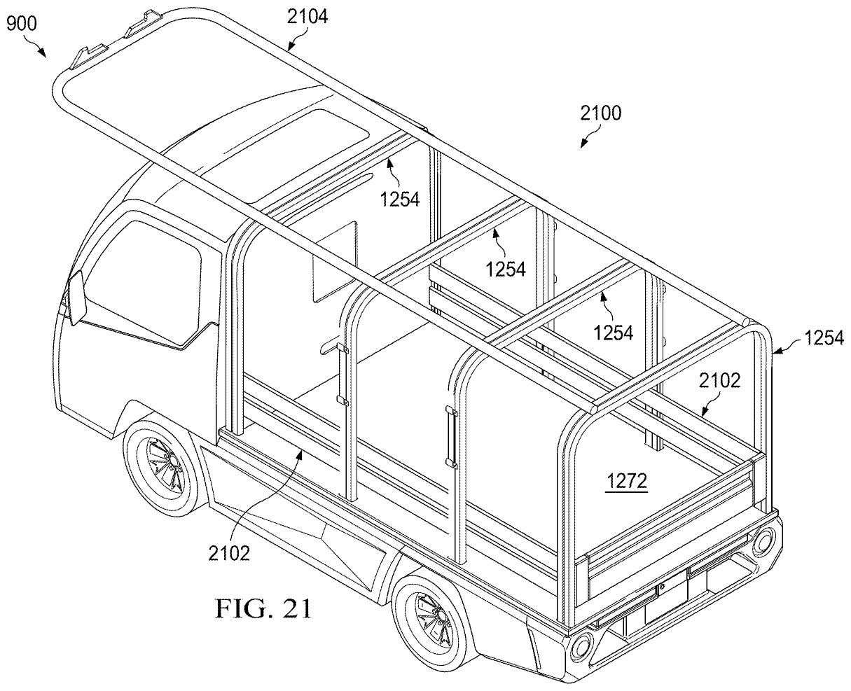

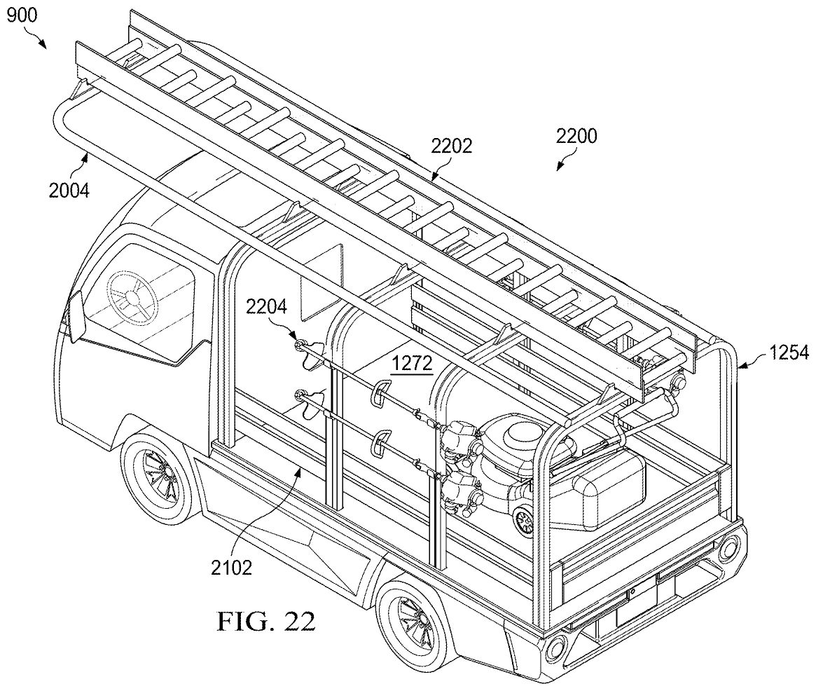

Referring to FIGS. 21 and 22, example payload configurations adding additional connection components and tool mounts to the reconfigurable payload system are illustrated. In the example of FIG. 21, reconfigurable payload system 900 is configured to have payload configuration 2100, where tool/ladder mounts 2104 are connected to the payload base 1272 (e.g., using horizontal bed arches 1254). Side bars 2102 are added to the payload base 1272 to provide more support. In the example of FIG. 22, reconfigurable payload system 900 is configured to have payload configuration 2200, for example, by securing ladder 2202 and landscape tools 2204 to the connection components (e.g., tool/ladder mounts 2104, horizontal bed arches 1254, etc.). Payload configuration 2200 may be chosen and used when the electric vehicle is used for providing landscape service, and is also referred to as a landscape payload configuration 2100.

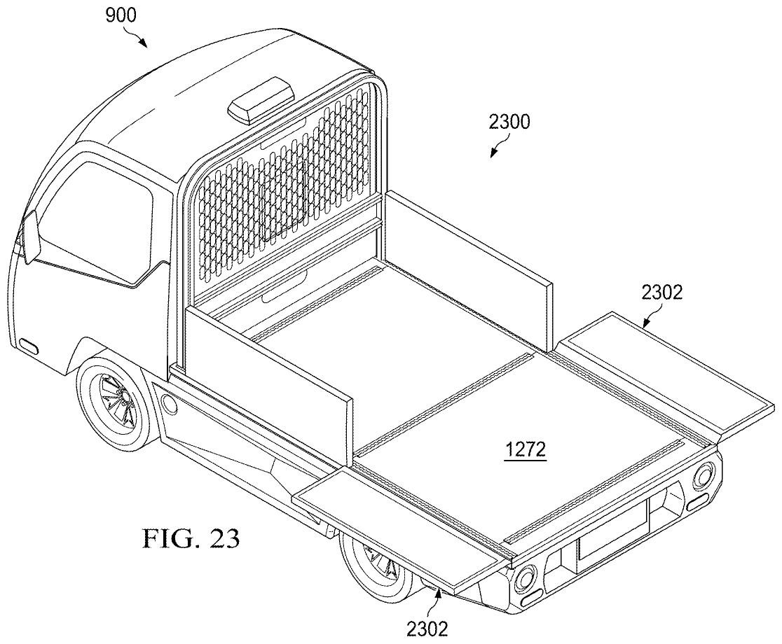

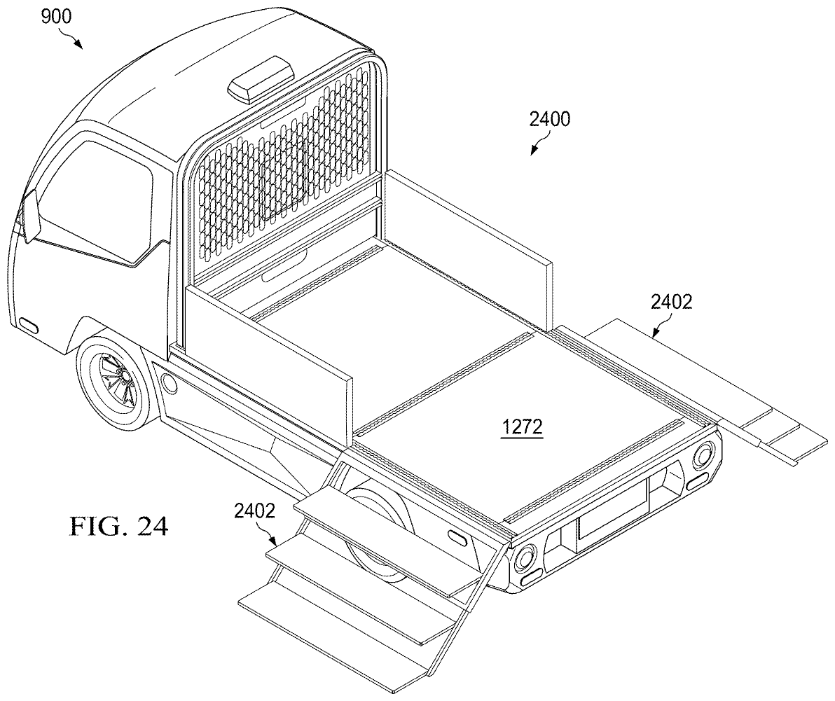

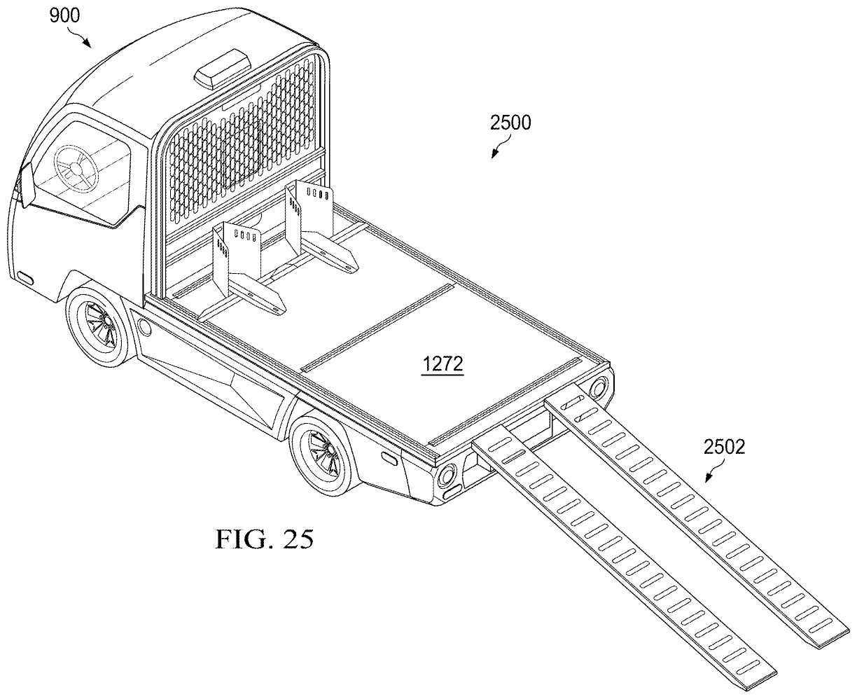

Referring to FIGS. 23, 24, and 25, example payload configurations providing corresponding functions are illustrated. In the example of FIG. 23, reconfigurable payload system 900 is configured to have payload configuration 2300, where hinged side panels 2302 may be fixed at desired positions, e.g., to provide increased work surface together with the surface of the payload base 1272. In the example of FIG. 24, reconfigurable payload system 900 is configured to have payload configuration 2400, providing a pickup bed using hinged side panels 2402. The hinged side panels 2402 may be pulled down to provide steps between the ground surface and the pickup bed. In the example of FIG. 25, reconfigurable payload system 900 is configured to have payload configuration 2500, where the payload base 1272 has storage spaces that may store components 2502 (e.g., ramps 2502 as shown in FIG. 25) that may be pulled out if needed.

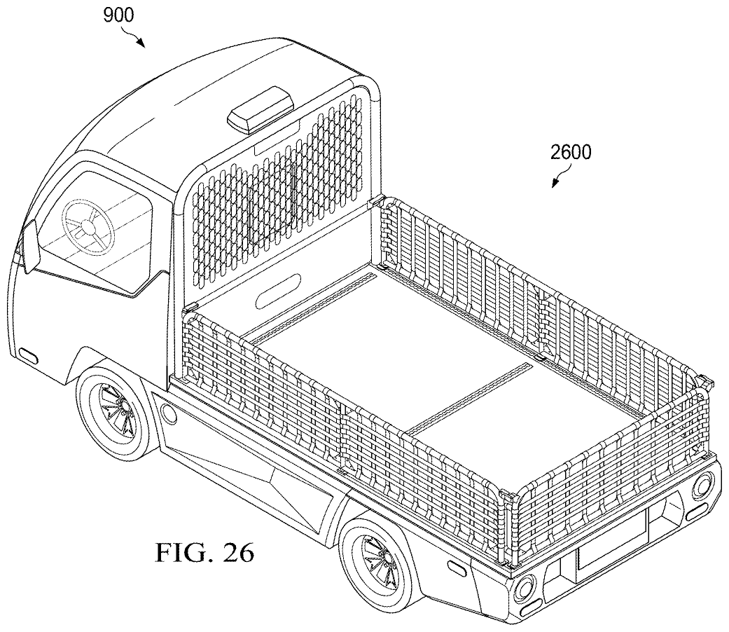

Referring to FIGS. 26, 27, 28, 29, 30, and 31, in various embodiments, payload configurations for an electric vehicle are designed and chosen, by using subcomponents of suitable construction configurations (e.g., shapes, perforation patterns, materials, hollow or solid constructions, etc.) to optimize efficiency (e.g., by weight/mass optimization/minimization) and achieve environmental impact minimization, while satisfying the payload capacity requirement. Various types of environmental impacts may be considered in the design of the payload configurations, including for example, surface impact, electromagnetic impact, noise impact, thermal impact, visual impact, etc. One or more subcomponents of the payload configurations may be made of various types of materials with different perforation patterns (e.g., webbing, canvas, perforated aluminum sheets, bamboo, structural hollow tube constructions, solid construction). In various embodiments, environmental impact is reduced by using renewable materials (e.g., bamboo) and/or recyclable materials (e.g., aluminum) to construct the subcomponents. In some embodiments, frame structures of the subcomponents for the reconfigurable payload system include box or tubular aluminum for reduced weight. In some embodiments, the frame structures of the subcomponents include composites, e.g., carbon composites, honeycomb composites, etc. for reduced weight. In some embodiments, various payload compartments and subcomponents include tubular aluminum or pattern-perforated sheet aluminum, where patterns, images, and logos in the sheet aluminum may be customized (e.g., for branding or other purposes). In some embodiments, the subcomponents for providing the roof structures of the reconfigurable payload system includes a weight minimized composite panel including embedded solar cells, which may be used to provide solar powered solution integrating sustainable solar power for the vehicle. In some embodiments, hollow mesh seats may be used for providing seats, e.g., for driver's seats, passengers' seats, and seats in the reconfigurable payload system (e.g., for mobile medical station payload pod).

As shown in the examples of FIGS. 26, 27, and 28, reconfigurable payload system 900 is reconfigured with payload configurations 2600, 2700, and 2800, where one or more subcomponents of the payload configurations 2600, 2700, and 2800 are made of materials with various patterns based on different payload capacity requirements and the local environment. While in the example payload configurations 2600, 2700, and 2800, the sub-components of the same payload configuration have similar construction configurations (e.g., patterns, materials, and hollow tube/solid constructions), reconfigurable payload system 900 may be configured a payload configuration, where subcomponents may have different construction configurations. It is also noted that one or more subcomponents of one payload configuration may be used to replace corresponding subcomponents of another payload configuration. In an example, reconfigurable payload system 900 with payload configuration 2600 may be reconfigured by replacing the tailgate with the tail gate of payload configuration 2700 or 2800. In another example, reconfigurable payload system 900 with payload configuration 2600 may be reconfigured by replacing the side gates with the side gates of payload configuration 2700 or 2800.

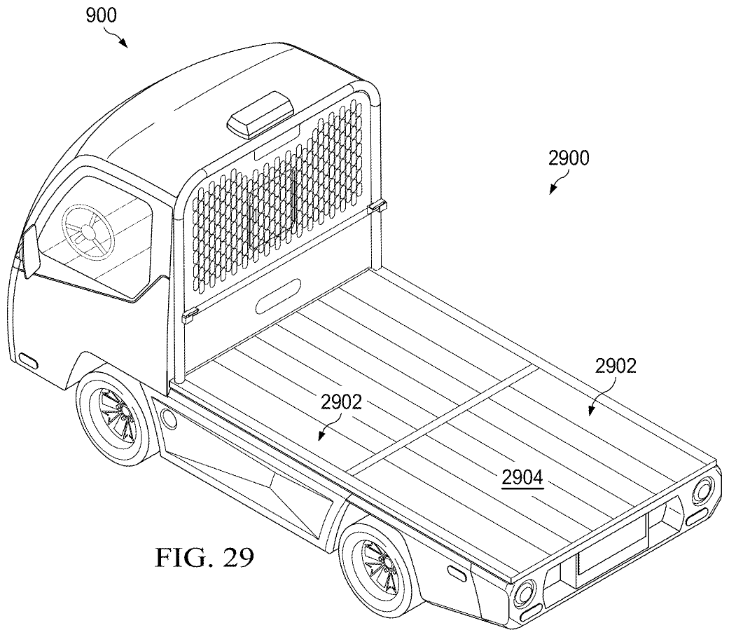

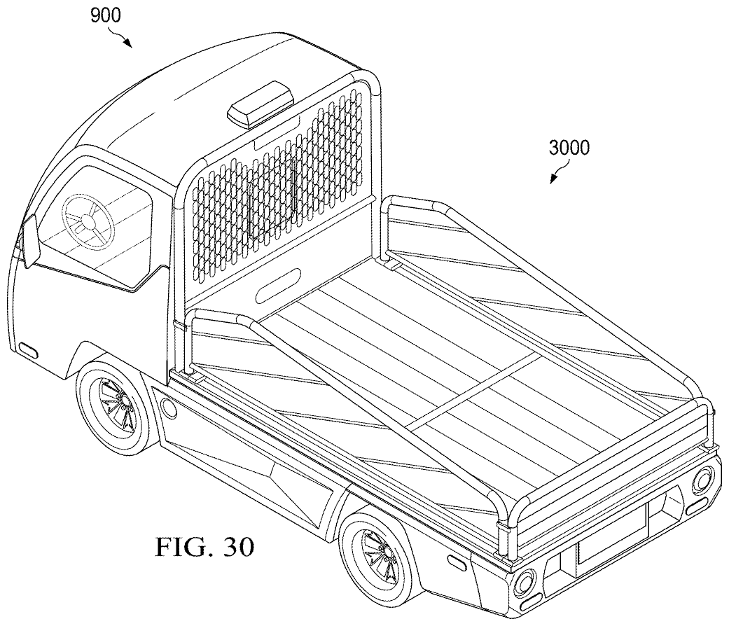

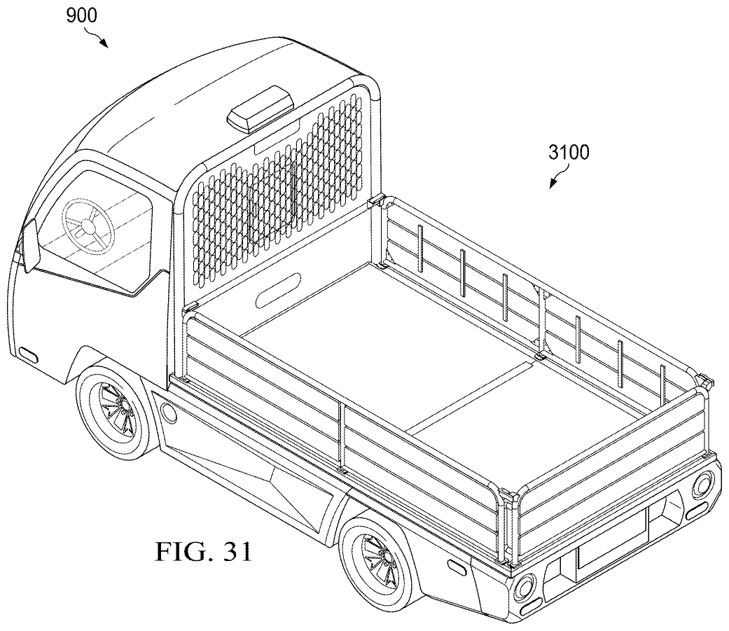

As shown in the examples of FIGS. 29, 30, and 31, reconfigurable payload system 900 is reconfigured with payload configurations 2900, 3000, and 3100, where the construction configurations of the payload base and subcomponents include using a combination of renewable materials (e.g., bamboo, canvas, etc.) and/or recyclable materials (e.g., aluminum, plastic, etc.). In the example of FIG. 29, reconfigurable payload system 900 is reconfigured with payload configuration 2900. Payload configuration 2900 provides a flatbed configuration, where the payload base includes side portions 2902 and center portion 2904, where the side portions 2902 are made of renewable materials (e.g., bamboo), and the center portion 2904 is made of another material, e.g., recyclable aluminum. In the example of FIGS. 30 and 31, reconfigurable payload system 900 having payload configuration 2900 is reconfigured with payload configurations 3000 and 3100, by connecting side panels and tail gates (e.g., made of bamboo panels and hollow metal frames) of different patterns to the payload base.

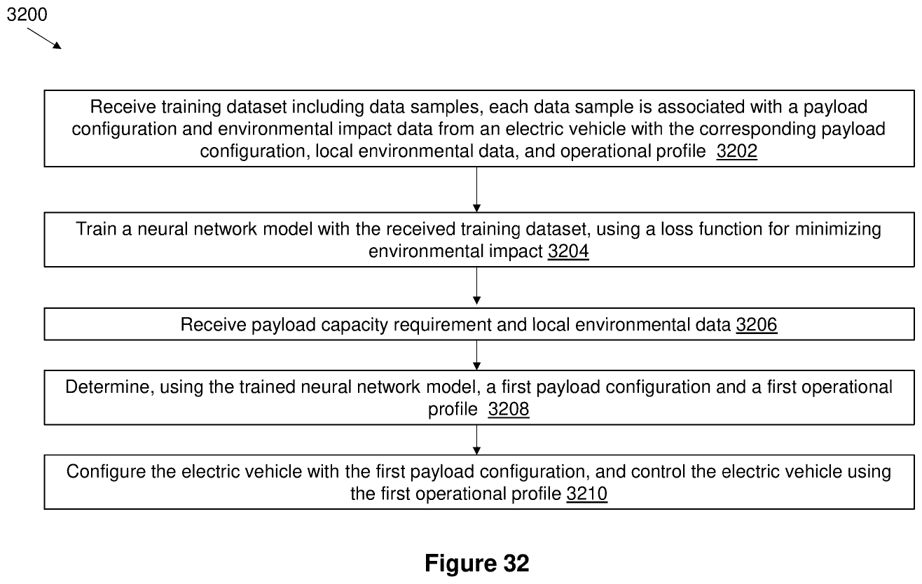

Referring to FIG. 32, an example method 3200 for using neural network models and machine learning to provide and control an electric vehicle with a reconfigurable payload system is illustrated. Method 3200 may begin at block 3202, where a payload configuration provider system (e.g., implemented using vehicular controller 220 or another computing device) receives a training dataset, where each data sample is associated with one of a plurality of payload configurations. The data sample also includes environmental impact data from an electric vehicle operated with the corresponding payload configuration, local environmental data, and operational profile.

The method 3200 may proceed to block 3204, where the payload configuration provider system trains a neural network model with the received training dataset. Various machine learning methods (e.g., supervised learning model, unsupervised learning model, reinforcement learning, etc.) may be used. In an example, the neural network model includes a reinforcement learning model, in which awards are assigned when environmental impact reduction is achieved, and intelligent agents take action to maximize the cumulative reward. Various optimization methods (e.g., gradient decent optimization, etc.) and loss functions (e.g., a loss function for minimizing the environmental impact) may be used for training the neural network model.

The method 3200 may proceed to block 3206, where the payload configuration provider system may receive a payload capacity requirement and local environmental data, automatically (e.g., using preconfigured payload capacity configurations and local environmental sensors) and/or manually by an operation. In an example, the payload configuration provider system may receive an automatically determined payload capacity requirement for lunch delivery (e.g., based on a current time of the day) and local environmental data (e.g., dry grass surface, slippery grass surface after rain, etc. based on data from local environmental sensors).

The method 3200 may proceed to block 3208, where the payload configuration provider system may, use the trained neural network model, determine a first payload configuration and a first operational profile, based on the received payload capacity requirement and local environmental data, to achieve optimized efficiency and minimized environmental impact.

The method 3200 may proceed to block 3210, where a reconfigurable payload system of the electric vehicle is reconfigured with the first payload configuration. The vehicular controller 220 may control the electric vehicle having the first payload configuration, using the first operational profile.

While the LSV could observe possible aberrant behavior and restrict such actions, the LSV system in general can collect use observations, aberrant or not, for future use. One use includes auditing the data, possibly for insurance purposes, to ensure the vehicles are properly used by or on behalf of a stakeholder (e.g., owner, lease holder, etc.). Another use can include compiling one or more machine learning training datasets. The training datasets can then be used to train machine learning models (e.g., artificial neural networks (ANNs), support-vector machines (SVM), random forests, Neuro-Evolution of Augmenting Topologies (NEAT), etc.) to identify acceptable or unacceptable behaviors. Additionally, such datasets can be leveraged to create automated routines or tasks that automated LSVs could take on in the future (e.g., lawn mowing, maintenance, delivery, etc.). In various embodiments, the disclosed techniques give rise to the ability to create automated or autonomous LSVs (e.g., drones, lawn mowers, snowplows, manned or unmanned vehicles, robots, etc.) that use the learned automate or routine tasks.

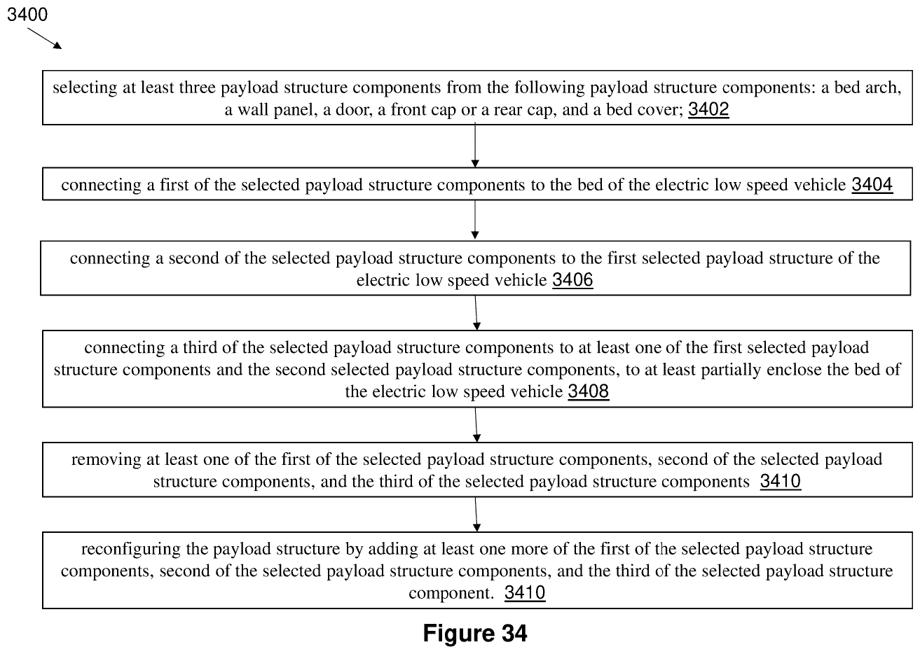

FIG. 34 identifies an example method 3400 of reconfiguring a payload structure by building the payload structure for a particular task and for reconfiguring the payload structure for a second task. The method may include at a process 3402, selecting at least three payload structure components from the following payload structure components: a bed arch, a wall panel, a door, a front cap or a rear cap, and a bed cover. The payload structure components may be selected from a plurality of each of bed arches, wall panels, doors, front caps or rear caps, and bed covers. In some instances, the payload structure components may be selected from a kit including a plurality of each of bed arches, wall panels, doors, front caps or rear caps, and bed covers, or a plurality of only some of each of the payload structure components.

At a process 3404, the method may include connecting a first of the selected payload structure components to the bed or payload base of the electric low speed vehicle. This may include connecting the bed arches as described herein.

At a process 3406, the method may include connecting a second of the selected payload structure components to the first selected payload structure of the electric low speed vehicle. This may include connecting wall panels, doors, front caps or rear caps, or bed covers to the bed arch as described herein.

At a process 3408, the method may include connecting a third of the selected payload structure components to at least one of the first selected payload structure components and the second selected payload structure components, to at least partially enclose the bed of the electric low speed vehicle. This may include connecting wall panels, doors, front caps or rear caps, or bed covers to the bed arch or the second component.

At a process 3410, the method may include removing at least one of the first of the selected payload structure components, second of the selected payload structure components, and the third of the selected payload structure components. This may enable a user to create a new different payload structure that could be better suited to a particular task. This makes the LSV more utilitarian by enabling it to be customized to be most effective in multiple uses.

At a process 3412, the method may include reconfiguring the payload structure by adding at least one more of the first of the selected payload structure components, second of the selected payload structure components, and the third of the selected payload structure component.

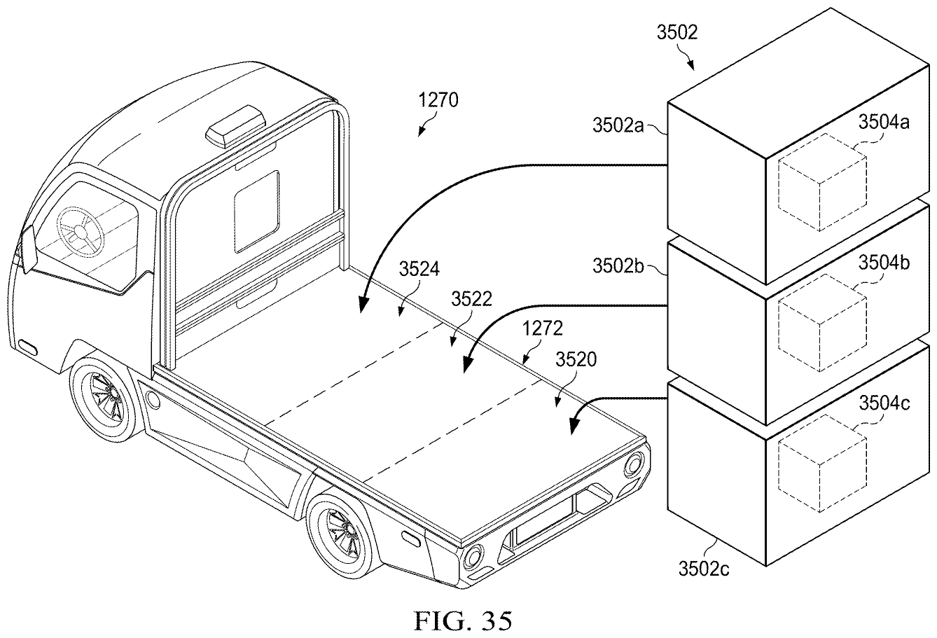

FIG. 35 illustrates a payload base pallet architecture that includes the electric vehicle of FIG. 12C with a reconfigurable payload system 1270 with the payload base 1272, and including preloaded pallet subsystems 3502 that are interchangeably connectable onto the payload base 1272. In this example, the payload base is divided into three sections, identified as sections 3520, 3522, and 3524. For reference, dashed lines separate the sections. However, it should be noted that the payload base 1272 may be divided into any number of sections. The sections 3520, 3522, and 3524 each define an area.

The preloaded pallet subsystems 3502 are sized to fit onto the payload base 1272, and as such, have an area that may correspond to the size of the sections 3520, 3522, and 3524. In this example, the preloaded pallet subsystems 3502 are arranged to fit side-by-side on the payload base 1272. The preloaded pallet subsystems 3502 may be secured in place and accessible by a user.

In this example, each of the preloaded pallet subsystems 3502 include pre-loaded, functional equipment 3504. The equipment 3504 could be identical or different from each other. As an example, the equipment 3504a-3504c could each be one of seats, lavatories, galleys, sleep compartments, beverage systems, or tool stations/workstations. As one example, the equipment 3504a may be a tool station, the equipment 3504b may be a beverage system, and the equipment 350c may be a workstation. In some examples, the user may have access to any number of different preloaded pallet subsystems 3502 or may have access to a plurality of the same preloaded pallet subsystems 3502 and different preloaded pallet subsystems 3502. As described with regard to the modular nature of the structures herein, the electric vehicle can be configured with preloaded pallet subsystems 3502 to meet needs of one type of particular task and then reconfigured with different preloaded pallet subsystems 3502 to meet needs of other particular tasks. As one example, the electric vehicle may be loaded with the preloaded pallet subsystems 3502 where preloaded pallet subsystems 3502a is a beverage subsystem, preloaded pallet subsystems 3502b is a galley or food service subsystem, and preloaded pallet subsystems 3502c is a workstation subsystem for providing towels or other items that might be convenient to consumers at a sporting event, such as on a golf course. Later, the preloaded pallet subsystems 3502a-3502c may be removed from the payload base 1272 and replaced with preloaded pallet subsystems that include a lavatory subsystem, a first aid workstation subsystem, and a washroom workstation subsystem for an event held at the sporting venue. Other examples are contemplated with other preloaded pallet subsystems.

In some examples, each preloaded pallet subsystem is self-contained and arranged with different equipment to accomplish desired tasks. By being self-contained, the preloaded pallet subsystem may include all plumbing, tanks, supplies, lighting, and other equipment that will make the preloaded pallet subsystem self-sustaining. Of course, supplies may be replenished as needed with the preloaded pallet subsystem on the payload base or off the payload base. Furthermore, because the preloaded pallet subsystems are modular and have the same size and construct on the outside of the module, they may be easily interchanged onto the payload base 1272.

Each of the preloaded pallet subsystems include fastening systems usable to secure them to the payload base 1272. In some examples, each of the pre-loaded pallet subsystems are sized so that at least two of the pre-loaded pallet subsystems simultaneously fit onto and are securable onto the payload base. In other example, four or more preloaded pallet subsystems may be sized to fit onto the payload base 1272. Although not described again, the preloaded pallet subsystems may be switched out according to the method in FIG. 34.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the vehicle. Connection references, e.g., attached, coupled, connected, and joined are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” Unless otherwise noted in the claims, stated values shall be interpreted as illustrative only and shall not be taken to be limiting.

The specification, examples and data provide a complete description of the structure and use of exemplary embodiments of the vehicle as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

It should be apparent to those skilled in the art that many more modifications besides those already described are possible without departing from the inventive concepts herein. The inventive subject matter, therefore, is not to be restricted except in the spirit of the appended claims. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification or claims refer to at least one of something selected from the group consisting of A, B, C . . . and N, the text should be interpreted as requiring only one element from the group, not A plus N, or B plus N, etc.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the inventive subject matter are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the inventive subject matter are approximations, the numerical values set forth in the specific examples are reported as precisely as practicable. The numerical values presented in some embodiments of the inventive subject matter may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the inventive subject matter and does not pose a limitation on the scope of the inventive subject matter otherwise claimed. No language in the specification should be construed as indicating any non-claimed element essential to the practice of the inventive subject matter.

Groupings of alternative elements or embodiments of the inventive subject matter disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

1. A method for providing a reconfigurable payload system for a low speed electric vehicle (LSV), comprising:
providing a payload base of the reconfigurable payload system, wherein the payload base includes a plurality of base connectors;
providing a plurality of modular subcomponents attachable to the base connectors of the payload base;
storing a plurality of operational profiles respectively associated with a plurality of payload configurations;
determining a first payload configuration from the plurality of payload configurations based on a first payload capability requirement for the LSV, wherein the first payload configuration is associated with a first subset of the plurality of modular subcomponents for connecting with a first subset of the plurality of base connectors;
providing the first subset of the plurality of subcomponents based on the first payload configuration;
configuring the reconfigurable payload system with the first payload configuration by attaching the first subset of the plurality of modular subcomponents to a first subset of the plurality of base connectors according to the first payload configuration to form a payload structure at least partially enclosing a bed of the LSV;
controlling the LSV configured with the first payload configuration with a first operational profile of the plurality of operational profiles to traverse a first area with a minimized environmental damage by a footprint,
wherein the first operational profile is associated with the first payload configuration.

2. The method of claim 1, further comprising:
receiving a training dataset including a plurality of data samples, wherein each data sample is associated with a payload configuration of the plurality of payload configurations and associated environmental impact data; and
training a first neural network model with the received training dataset with a loss function for minimizing the environmental impact;
wherein the determining the first payload configuration includes:
providing, using the trained neural network model, the first payload configuration, based on the first payload capability requirement.

3. The method of claim 2, wherein the neural network model includes a reinforcement learning model; and
wherein the training the neural network model includes:
assigning awards when environmental impact reduction is achieved; and
maximizing, using intelligent agents of the reinforcement learning model, to maximize a cumulative reward.

4. The method of claim 2, further comprising:
determining, using one or more local environmental sensors, first local environmental data of the first area;
wherein the first payload configuration is provided, using the trained neural network model, based on the first payload capability requirement and the first local environmental data; and
wherein each data sample includes associated local environmental data.

5. The method of claim 2,
wherein the first operational profile is determined, using the trained neural network model, based on the first payload capability requirement; and
wherein each sample includes an associated operational profile.

6. The method of claim 1, wherein the LSV is configured with a second payload configuration by:
loading a payload pod preconfigured with the second payload configuration to the payload base of the reconfigurable payload system.

7. The method of claim 6, wherein the payload pod is loaded, based on the second payload configuration, with a plurality of independently loadable bolt-on cargos, including seats, lavatories, galleys, sleep compartments, beverage systems, or tool stations/workstations.

8. The method of claim 1,
wherein the payload base includes a base plate, wherein the base plate is configured to lift, using a riser, to create a roll-on, roll-off cargo configuration; and
wherein the riser is configured to operate laterally to permit cargo roll-on, roll-off from either side laterally.

9. The method of claim 1, wherein the reconfigurable payload system reconfigured with the first payload configuration includes:
at least two modular wall structures attachable to the plurality of base connectors to form the payload structure at least partially enclosing a bed of the LSV, each modular wall structure comprising one of:
a rigid wall panel selectively connectable with at least one base connector of the plurality of base connectors; or
a rigid door selectively connectable with at least one base connector of the plurality of base connectors; or
a rigid front cap or a rear cap selectively connectable with at least one base connector of the plurality of base connectors; or
a rigid bed cover selectively connectable with at least one base connector of the plurality of base connectors.

10. The method of claim 1, further comprising:
determining a second payload configuration from the plurality of payload configurations based on a second payload capability requirement for the LSV,
wherein the second payload configuration is associated with a second subset of the plurality of modular subcomponents different from the first subset of the plurality of modular subcomponents; and
controlling the LSV configured with the second payload configuration to traverse a second area with a minimal environmental impact.

11. A system, comprising:
a non-transitory memory; and
one or more hardware processors coupled to the non-transitory memory and configured to read instructions from the non-transitory memory to cause the system to perform a method for providing a reconfigurable payload system for a low speed electric vehicle (LSV), comprising:
providing a payload base of the reconfigurable payload system, wherein the payload base includes a plurality of base connectors;
providing a plurality of modular subcomponents attachable to the base connectors of the payload base;
storing a plurality of operational profiles respectively associated with a plurality of payload configurations, wherein each payload configuration is associated with a subset of the plurality of modular subcomponents for connecting with a subset of the plurality of base connectors;
determining a first payload configuration from the plurality of payload configurations based on a first payload capability requirement for the LSV;
providing, from the plurality of modular subcomponents, a first subset of the plurality of modular subcomponents based on the first payload configuration;
configuring the reconfigurable payload system with the first payload configuration by attaching the first subset of the plurality of modular subcomponents to a first subset of the plurality of base connectors according to the first payload configuration to form a payload structure at least partially enclosing a bed of the LSV;
controlling the LSV configured with the first payload configuration with a first operational profile of the plurality of operational profiles to traverse a first area with a minimized environmental damage by a footprint,
wherein the first operational profile is associated with the first payload configuration.

12. The system of claim 11, wherein the method includes:
receiving a training dataset including a plurality of data samples, wherein each data sample is associated with a payload configuration of the plurality of payload configurations and associated environmental impact data; and
training a first neural network model with the received training dataset with a loss function for minimizing the environmental impact;
wherein the determining the first payload configuration includes:
providing, using the trained neural network model, the first payload configuration, based on the first payload capability requirement.

13. The system of claim 12, wherein the neural network model includes a reinforcement learning model; and
wherein the training the neural network model includes:
assigning awards when environmental impact reduction is achieved; and
maximizing, using intelligent agents of the reinforcement learning model, to maximize a cumulative reward.

14. The system of claim 12, wherein the method further comprises:
determining, using one or more local environmental sensors, first local environmental data of the first area;
wherein the first payload configuration is provided, using the trained neural network model, based on the first payload capability requirement and the first local environmental data; and
wherein each data sample includes associated local environmental data.

15. The system of claim 12,
wherein the first operational profile is determined, using the trained neural network model, based on the first payload capability requirement; and
wherein each sample includes an associated operational profile.

16. The system of claim 11, wherein the LSV is reconfigured with a second payload configuration by:
loading a payload pod preconfigured with the second payload configuration to the payload base of the reconfigurable payload system.

17. The system of claim 16, wherein the payload pod is loaded, based on the second payload configuration, with a plurality of independently loadable bolt-on cargos, including seats, lavatories, galleys, sleep compartments, beverage systems, or tool stations/workstations.

18. The system of claim 11,
wherein the payload base includes a base plate, wherein the base plate is configured to lift, using a riser, to create a roll-on, roll-off cargo configuration; and
wherein the riser is configured to operate laterally to permit cargo roll-on, roll-off from either side laterally.

19. The system of claim 11, wherein the reconfigurable payload system reconfigured with the first payload configuration includes:
at least two modular wall structures attachable to the plurality of base connectors to form the payload structure at least partially enclosing a bed of the LSV, each modular wall structure comprising one of:
a rigid wall panel selectively connectable with at least one base connector of the plurality of base connectors; or
a rigid door selectively connectable with at least one base connector of the plurality of base connectors; or
a rigid front cap or a rear cap selectively connectable with at least one base connector of the plurality of base connectors; or
a rigid bed cover selectively connectable with at least one base connector of the plurality of base connectors.

20. The system of claim 11, wherein the method further comprises:
determining a second payload configuration from the plurality of payload configurations based on a second payload capability requirement for the LSV, wherein the second payload configuration is associated with a second subset of the plurality of modular subcomponents different from the first subset of the plurality of modular subcomponents; and
controlling the LSV configured with the second payload configuration to traverse a second area with a minimal environmental impact.
